(19) United States
(12) Patent Application Publication
(10) Pub. No.: US 2026/0046751 A1
(43) Pub. Date: Feb. 12, 2026

(54) VERSION IDENTIFIERS FOR REMAINING MINIMUM SYSTEM INFORMATION

(71) Applicant: QUALCOMM Incorporated, San Diego, CA (US)

(72) Inventors: Mostafa KHOSHNEVISAN, San Diego, CA (US); Jing SUN, San Diego, CA (US); Yan ZHOU, San Diego, CA (US)

(21) Appl. No.: 18/796,899

(22) Filed: Aug. 7, 2024

(51) Int. Cl. H04W 48/16; H04L 5/00

(52) U.S. Cl. CPC H04W 48/16; H04L 5/0053

(57) ABSTRACT

Methods, systems, and devices for wireless communications are described. Remaining minimum system information (RMSI) (e.g., system information block one (SIB1)) may be associated with version identifiers (IDs). The master information block (MIB) in a physical broadcast channel (PBCH) transmission may include an indication of version ID associated with RMSI transmitted by the corresponding cell for a given time window. Accordingly, during a time window after the PBCH transmission, a user equipment (UE) which receives the PBCH transmission may determine whether to decode a subsequent RMSI physical downlink shared channel transmission for the cell based on whether the UE previously successfully decoded an RMSI associated with the version ID indicated by the PBCH transmission.

### FIELD OF TECHNOLOGY

The following relates to wireless communications, including version identifiers for remaining minimum system information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first remaining minimum system information (RMSI) via a first RMSI message, where the first RMSI message indicates a first identifier (ID) associated with the first RMSI, receiving, from a cell and after the first RMSI message, a physical broadcast channel (PBCH) transmission that indicates a second ID associated with second RMSI associated with the cell during a time window, and selecting to decode or refrain from decoding a second RMSI message associated with the cell during the time window based on whether the first ID matches the second ID.

A UE for wireless communications is described. The UE may include one or more memories storing processor executable code, and one or more processors coupled with the one or more memories. The one or more processors may individually or collectively be operable to execute the code to cause the UE to receive first RMSI via a first RMSI message, where the first RMSI message indicates a first ID associated with the first RMSI, receive, from a cell and after the first RMSI message, a PBCH transmission that indicates a second ID associated with second RMSI associated with the cell during a time window, and select to decode or refrain from decoding a second RMSI message associated with the cell during the time window based on whether the first ID matches the second ID.

Another UE for wireless communications is described. The UE may include means for receiving first RMSI via a first RMSI message, where the first RMSI message indicates a first ID associated with the first RMSI, means for receiving, from a cell and after the first RMSI message, a PBCH transmission that indicates a second ID associated with second RMSI associated with the cell during a time window, and means for selecting to decode or refrain from decoding a second RMSI message associated with the cell during the time window based on whether the first ID matches the second ID.

A non-transitory computer-readable medium storing code for wireless communications is described. The code may include instructions executable by one or more processors to receive first RMSI via a first RMSI message, where the first RMSI message indicates a first ID associated with the first RMSI, receive, from a cell and after the first RMSI message, a PBCH transmission that indicates a second ID associated with second RMSI associated with the cell during a time window, and select to decode or refrain from decoding a second RMSI message associated with the cell during the time window based on whether the first ID matches the second ID.

In some examples of the method, UEs, and non-transitory computer-readable medium described herein, selecting to decode or refrain from decoding the second RMSI message may include operations, features, means, or instructions for selecting to refrain from decoding the second RMSI message based on the first ID matching the second ID, where the first ID matching the second ID may be indicative that the first RMSI may be a same as the second RMSI.

Some examples of the method, UEs, and non-transitory computer-readable medium described herein may further include operations, features, means, or instructions for receiving, from a second cell and prior to the time window, one or more first additional system information (SI) messages that include first cell-specific information associated with the second cell, where the first RMSI message may be received from the second cell, and where the first RMSI message includes information common to the second cell and the cell and receiving, from the cell and after the PBCH transmission, one or more second additional SI messages that include second cell-specific information associated with the cell.

In some examples of the method, UEs, and non-transitory computer-readable medium described herein, receiving the first RMSI message may include operations, features, means, or instructions for receiving the first RMSI message from a second cell, where the first RMSI message includes a set of bits, where an interpretation of the set of bits may be cell-dependent.

In some examples of the method, UEs, and non-transitory computer-readable medium described herein, selecting to decode or refrain from decoding the second RMSI message may include operations, features, means, or instructions for selecting to decode the second RMSI message based on the first ID having a different value than the second ID, where the first ID having the different value than the second ID may be indicative that the first RMSI may be different than the second RMSI.

In some examples of the method, UEs, and non-transitory computer-readable medium described herein, the second RMSI message includes an indication of the second ID associated with the second RMSI.

In some examples of the method, UEs, and non-transitory computer-readable medium described herein, the second RMSI message includes an indication of a third ID different than the second ID and the method, apparatuses, and non-transitory computer-readable medium may include further operations, features, means, or instructions for determining, based on the third ID having the different value than the second ID, that the second RMSI may be associated with the third ID.

In some examples of the method, UEs, and non-transitory computer-readable medium described herein, the second RMSI message includes an indication of a third ID different than the second ID and the method, apparatuses, and non-transitory computer-readable medium may include further operations, features, means, or instructions for determining, based on the third ID having the different value than the second ID, that the second RMSI may be associated with the second ID.

In some examples of the method, UEs, and non-transitory computer-readable medium described herein, a temporal beginning of the time window may be based on a reception time of the PBCH transmission.

In some examples of the method, UEs, and non-transitory computer-readable medium described herein, receiving the PBCH transmission may include operations, features, means, or instructions for receiving an indication of a duration of the time window.

In some examples of the method, UEs, and non-transitory computer-readable medium described herein, the time window includes a fixed quantity of radio frames.

In some examples of the method, UEs, and non-transitory computer-readable medium described herein, receiving the PBCH transmission may include operations, features, means, or instructions for receiving an indication a quantity of radio frames included in the time window.

Some examples of the method, UEs, and non-transitory computer-readable medium described herein may further include operations, features, means, or instructions for receiving, from the cell and during the time window, a second PBCH transmission that indicates the second ID associated with the second RMSI, where the second PBCH transmission indicates the quantity of radio frames included in the time window.

In some examples of the method, UEs, and non-transitory computer-readable medium described herein, selectively decoding or refraining from decoding the second RMSI message may include operations, features, means, or instructions for decoding the second RMSI message based on the first RMSI message being received from a second cell different than the cell.

In some examples of the method, UEs, and non-transitory computer-readable medium described herein, receiving the first RMSI message may include operations, features, means, or instructions for receiving the first RMSI message while in a first radio resource control state, and where receiving the PBCH transmission includes receiving the PBCH transmission while in a second radio resource control state different than the first radio resource control state.

Some examples of the method, UEs, and non-transitory computer-readable medium described herein may further include operations, features, means, or instructions for receiving, from the cell, a control message that indicates a list of neighbor cells and a respective ID associated with RMSI for each neighbor cell.

Some examples of the method, UEs, and non-transitory computer-readable medium described herein may further include operations, features, means, or instructions for deleting the first RMSI from memory of the UE based on a duration since reception of the first RMSI message, a quantity of RMSI messages stored in memory of the UE exceeding a threshold, control signaling received from the cell or a second cell indicating to delete the first RMSI, or a combination thereof.

A method for wireless communications by a network entity is described. The method may include outputting, to a UE, first RMSI via a first RMSI message associated with a cell, where the first RMSI message indicates a first ID associated with the first RMSI, and where the cell is associated with the network entity and outputting, to the UE and after the first RMSI message, a PBCH transmission that indicates a second ID associated with second RMSI associated with the cell during a time window.

A network entity for wireless communications is described. The network entity may include one or more memories storing processor executable code, and one or more processors coupled with the one or more memories. The one or more processors may individually or collectively be operable to execute the code to cause the network entity to output, to a UE, first RMSI via a first RMSI message associated with a cell, where the first RMSI message indicates a first ID associated with the first RMSI, and where the cell is associated with the network entity and output, to the UE and after the first RMSI message, a PBCH transmission that indicates a second ID associated with second RMSI associated with the cell during a time window.

Another network entity for wireless communications is described. The network entity may include means for outputting, to a UE, first RMSI via a first RMSI message associated with a cell, where the first RMSI message indicates a first ID associated with the first RMSI, and where the cell is associated with the network entity and means for outputting, to the UE and after the first RMSI message, a PBCH transmission that indicates a second ID associated with second RMSI associated with the cell during a time window.

A non-transitory computer-readable medium storing code for wireless communications is described. The code may include instructions executable by one or more processors to output, to a UE, first RMSI via a first RMSI message associated with a cell, where the first RMSI message indicates a first ID associated with the first RMSI, and where the cell is associated with the network entity and output, to the UE and after the first RMSI message, a PBCH transmission that indicates a second ID associated with second RMSI associated with the cell during a time window.

In some examples of the method, network entities, and non-transitory computer-readable medium described herein, the first ID matches the second ID and the first ID matching the second ID may be indicative that the first RMSI message may be a same as the second RMSI.

In some examples of the method, network entities, and non-transitory computer-readable medium described herein, the first ID may have a different value than the second ID and the first ID having the different value than the second ID may be indicative that the first RMSI message may be different than the second RMSI.

In some examples of the method, network entities, and non-transitory computer-readable medium described herein, a temporal beginning of the time window may be based on a transmission time of the PBCH transmission.

In some examples of the method, network entities, and non-transitory computer-readable medium described herein, outputting the PBCH transmission may include operations, features, means, or instructions for outputting an indication of a duration of the time window.

In some examples of the method, network entities, and non-transitory computer-readable medium described herein, the time window includes a fixed quantity of radio frames.

In some examples of the method, network entities, and non-transitory computer-readable medium described herein, outputting the PBCH transmission may include operations, features, means, or instructions for outputting an indication a quantity of radio frames included in the time window.

Some examples of the method, network entities, and non-transitory computer-readable medium described herein may further include operations, features, means, or instructions for outputting, to the UE and during the time window, a second PBCH transmission that indicates the second ID associated with the second RMSI, where the second PBCH transmission indicates the quantity of radio frames included in the time window.

Some examples of the method, network entities, and non-transitory computer-readable medium described herein may further include operations, features, means, or instructions for outputting the first RMSI message while the UE may be in a first radio resource control state, and where outputting the PBCH transmission includes outputting the PBCH transmission while the UE may be in a second radio resource control state different than the first radio resource control state.

Some examples of the method, network entities, and non-transitory computer-readable medium described herein may further include operations, features, means, or instructions for outputting, to the UE, a control message that indicates a list of neighbor cells and a respective ID associated with RMSI for each neighbor cell.

Some examples of the method, network entities, and non-transitory computer-readable medium described herein may further include operations, features, means, or instructions for outputting, to the UE, control signaling that indicates to delete the first RMSI.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports version identifiers (IDs) for remaining minimum system information (RMSI) in accordance with one or more aspects of the present disclosure.

FIG. 2 shows an example of a synchronization signal block (SSB) resource diagram that supports version IDs for RMSI in accordance with one or more aspects of the present disclosure.

FIG. 3 shows examples of diagrams of SSB and RMSI multiplexing patterns that support version IDs for RMSI in accordance with one or more aspects of the present disclosure.

FIG. 4 shows an example of a wireless communications system that supports version IDs for RMSI in accordance with one or more aspects of the present disclosure.

FIG. 5 shows an example of a version ID time window diagram that supports version IDs for RMSI in accordance with one or more aspects of the present disclosure.

FIG. 6 shows an example of a version ID time window diagram that supports version IDs for RMSI in accordance with one or more aspects of the present disclosure.

FIG. 7 shows an example of a process flow that supports version IDs for RMSI in accordance with one or more aspects of the present disclosure.

FIGS. 8 and 9 show block diagrams of devices that support version IDs for RMSI in accordance with one or more aspects of the present disclosure.

FIG. 10 shows a block diagram of a communications manager that supports version IDs for RMSI in accordance with one or more aspects of the present disclosure.

FIG. 11 shows a diagram of a system including a device that supports version IDs for RMSI in accordance with one or more aspects of the present disclosure.

FIGS. 12 and 13 show block diagrams of devices that support version IDs for RMSI in accordance with one or more aspects of the present disclosure.

FIG. 14 shows a block diagram of a communications manager that supports version IDs for RMSI in accordance with one or more aspects of the present disclosure.

FIG. 15 shows a diagram of a system including a device that supports version IDs for RMSI in accordance with one or more aspects of the present disclosure.

FIGS. 16 and 17 show flowcharts illustrating methods that support version IDs for RMSI in accordance with one or more aspects of the present disclosure.

### DETAILED DESCRIPTION

In wireless communications systems, a user equipment (UE) may monitor for synchronization signal blocks (SSBs) from a cell to perform cell or beam search and/or selection. A cell may transmit SSBs via multiple beams (e.g., may perform beam sweeping of SSBs), and the UE may measure the SSBs to select a cell and beam to access based on the measurements of the SSBs. An SSB may be transmitted over four symbols. An SSB may include a primary synchronization signal (PSS) in a first symbol, a physical broadcast channel (PBCH) transmitted over the subsequent three symbols, and a secondary synchronization signal (SSS) multiplexed with the PBCH transmission on the third symbol. The PSS and the SSS together may indicate the cell ID (e.g., the physical cell identifier (PCI)) of the cell that transmitted the SSB. The UE also may use the PSS and SSS to synchronize timing with the cell and to decode the PBCH transmission. The PBCH may convey a master information block (MIB) for the cell which may include an indication of a physical downlink control channel (PDCCH) occasion to monitor. The PDCCH in the indicated PDCCH occasion may include scheduling information for a physical downlink shared channel (PDSCH) transmission that conveys remaining minimum system information (RMSI) (e.g., a system information block one (SIB1)) for the cell. The RMSI may be used to perform an access procedure with the cell (e.g., to perform a random access channel (RACH) procedure with the cell).

RMSI and SSBs may be periodically transmitted. In some examples, to save power at the network, RMSI may be transmitted less frequently than the SSBs. The content of RMSI may be relatively static (e.g., does not change frequently). The coding rate of RMSI may be high, and thus the UE may be able to decode the SSB but may not be able to decode RMSI under some channel conditions. Thus, decoding of RMSI may be a bottleneck to cell access in some channel conditions.

Aspects of this disclosure relate to the use of version IDs with RMSI. For example, each RMSI may include an indication of a version identifier (ID) associated with the RMSI. Each PBCH may include an indication of the version ID associated with RMSI transmitted by the corresponding cell for a given time window. For example, the MIB conveyed by the PBCH may indicate the version ID. Thus, during the time window, in the case where a UE has previously decoded an RMSI with the version ID indicated by a PBCH, the UE may refrain from decoding another RMSI with that version ID. During the time window, in the case where the UE has not previously decoded another RMSI with the indicated ID, the UE may decode an RMSI from the cell. Thus, in the case that the UE has previously decoded an RMSI with the version ID indicated by a PBCH, the UE may access the cell in poor channel conditions under which the UE would otherwise be unable to decode an RMSI or would demand multiple repetitions in order to decode the RMSI.

Aspects of the disclosure are initially described in the context of wireless communications systems. Aspects of the disclosure are further illustrated by and described with reference to SSB resource diagrams, diagrams of SSB and RMSI multiplexing patterns, version ID time window diagrams, process flows, apparatus diagrams, system diagrams, and flowcharts that relate to version IDs for RMSI.

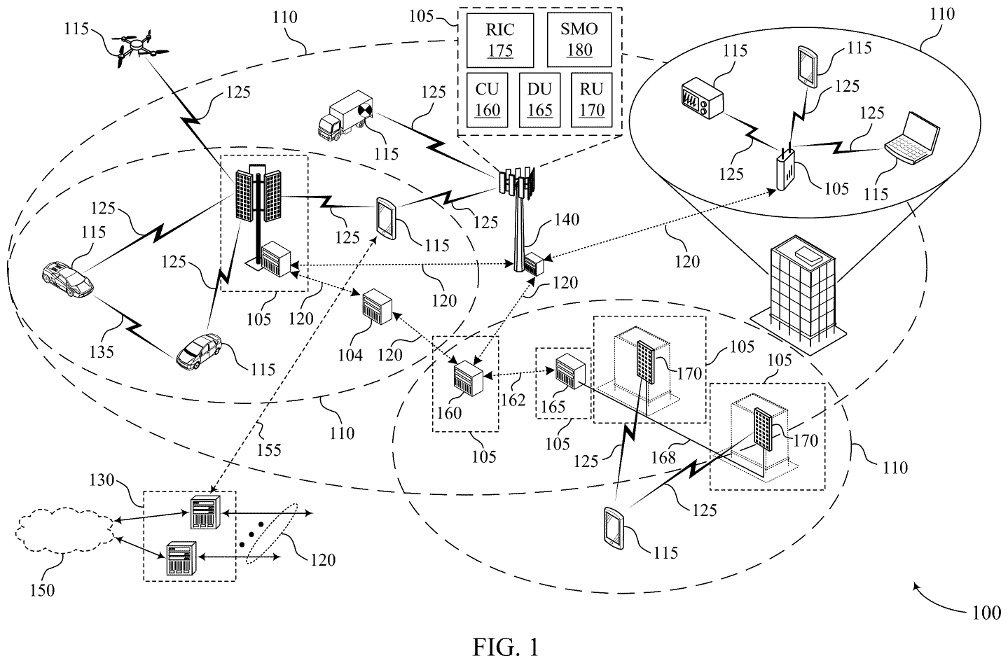

FIG. 1 shows an example of a wireless communications system 100 that supports version IDs for RMSI in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information (SI)), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., ten milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In the wireless communications system 100, a UE 115 may monitor for SSBs from a cell (e.g., transmitted by a network entity 105) as a part of an initial cell search. The PSS and the SSS of an SSB together may indicate the cell ID (e.g., the PCI) of the cell that transmitted the SSB. The UE 115 also may use the PSS and SSS to synchronize timing with the cell and to decode the PBCH transmission of the SSB. The PBCH transmission may convey MIB which may include SI for the cell and may include scheduling information for a PDCCH occasion for the UE 115 to monitor. The PDCCH transmission in the indicated PDCCH occasion may include scheduling information for a PDSCH transmission that includes RMSI for the cell. The RMSI may be used to perform an access procedure with the cell (e.g., a RACH procedure). RMSI and SSBs may be periodically transmitted. In some examples, to save power at the network entity 105, RMSI may be transmitted less frequently than the SSBs. The coding rate of RMSI may be higher than the coding rate of SSBs (e.g., the code rate of PBCH/MIB of SSBs), and thus the UE 115 may be able to decode the SSB (e.g., decode PBCH/MIB and/or detect PSS/SSS) but may not be able to decode RMSI under some channel conditions.

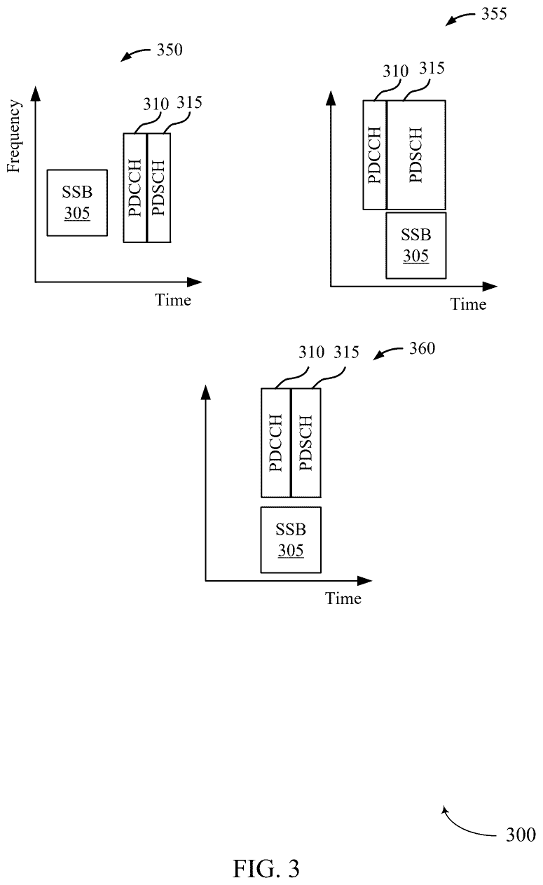

RMSI content (e.g., SIB1) may not change frequently and may be relatively static over time and across different network entities, cells, PCIs, frequency ranges, bands, or component carriers. For frequency range 2 (FR2) with SSB multiplexing patterns two and three (e.g., as described with reference to FIG. 3), the coding rate of RMSI may be high, and thus decoding of the PDSCH that conveys RMSI may be a coverage bottleneck as compared to other channels for initial access (e.g., the PBCH and/or the PDCCH). In some examples, a UE 115 may use repetitions of RMSI received within an RMSI period in order to correctly decode the RMSI. For example, the UE 115 may soft-combine multiple RMSI PDSCH transmissions to decode the RMSI. Transmitting repetitions of RMSI PDSCH however, may increase network energy consumption and may increase communication resource overhead used for RMSI.

Accordingly, RMSI version IDs may be used to enable a UE 115 to use a previously decoded RMSI. For example, a UE 115 may have previously successfully decoded an RMSI when the UE 115 was closer to a cell center (e.g., was closer to the network entity 105 associated with a cell). The UE 115 may use the previously decoded RMSI when the UE 115 is at a cell edge (e.g., which may be the same or a different cell) if the RMSI version IDs match. For example, a UE 115 may receive a PBCH (e.g., a MIB) from a cell which may include an indication of the version ID associated with RMSI transmitted by the corresponding cell for a given time window. Thus, during the time window, in the case where a UE 115 has previously decoded an RMSI with the ID indicated by a PBCH, the UE 115 may refrain from decoding another RMSI with that ID. Thus, in scenarios where the UE 115 cannot successfully decode the RMSI, the UE 115 may use a previously decoded RMSI if the MIB indicates the RMSI associated with the cell is associated with a version ID that matches a version ID of an RMSI the UE 115 previously successfully decoded. During the time window, in the case where the UE 115 has not previously decoded another RMSI with the indicated ID, the UE 115 may decode an RMSI from the cell.

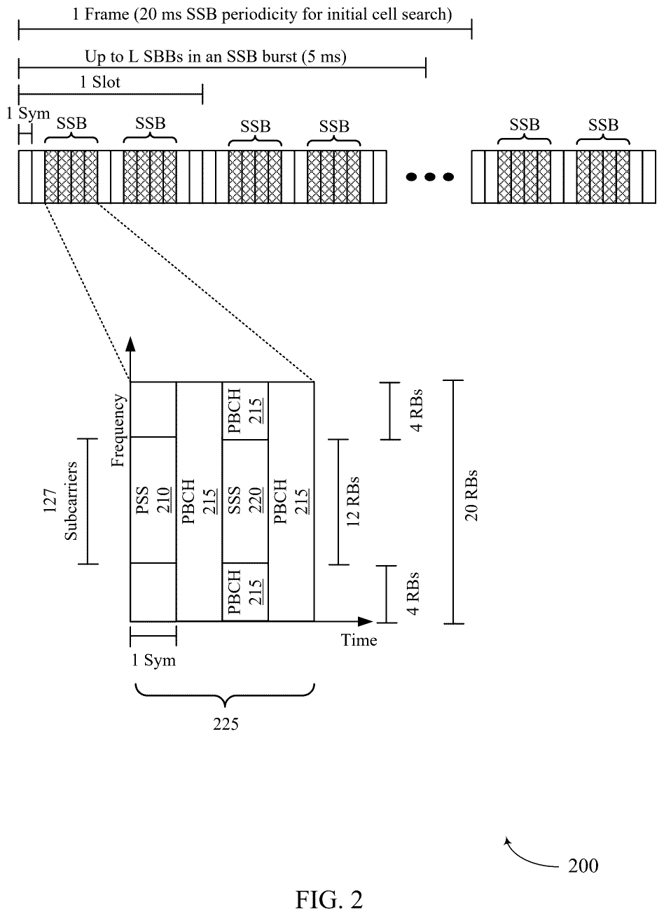

FIG. 2 shows an example of an SSB resource diagram 200 that supports version IDs for RMSI in accordance with one or more aspects of the present disclosure. The SSB resource diagram 200 may implement or may be implemented by aspects of the wireless communications system 100.

As described herein, an SSB 225 may include four symbols and may include a PSS 210, a PBCH transmission 215, and an SSS 220. The PSS 210 may be transmitted in a temporally first symbol of the SSB 225, the PBCH transmission 215 may be transmitted in the next three symbols of the SSB 225, and the SSS 220 may be frequency-division multiplexed with the PBCH transmission 215 on the temporally third symbol of the SSB 225. For example, the PSS 210 may be transmitted on 127 subcarriers in the temporally first symbol (e.g., twelve resource blocks (RBs)). In the temporally second symbol and the temporally fourth symbol of the SSB 225, the PBCH transmission 215 may be transmitted over 20 RBs. In the temporally third symbol of the SSB 225, the SSS 220 may be transmitted over the middle twelve RBs, and the PBCH transmission 215 may be transmitted on four RBs higher in frequency than the middle twelve RBs and four RBs lower in frequency than the middle twelve RBs.

A cell may periodically transmit SSBs 225 via multiple beams, and the UE 115 may measure the SSBs to select a cell and beam to access. For example, the cell may transmit a burst of SSBs via multiple beams, which the UE 115 may measure to select a cell and beam. For example, as shown in the SSB resource diagram 200, a cell may transmit multiple SSBs (e.g., two as shown in FIG. 2) per slot, and may transmit up to L SSBs in an SSB burst (e.g., a five ms burst). A cell may periodically transmit SSB bursts in accordance with an SSB periodicity, (e.g., one burst per two radio frames (e.g., 20 ms)). For example, the SSB periodicity may be 20 ms.

FIG. 3 shows an example diagram 350 of an SSB and RMSI multiplexing pattern, an example diagram 355 of an SSB and RMSI multiplexing pattern, and an example diagram 360 of an SSB and RMSI multiplexing pattern that support version IDs for RMSI in accordance with one or more aspects of the present disclosure. The diagram 350, the diagram 355, and the diagram 360 may implement or may be implemented by aspects of the wireless communications system 100.

Multiple multiplexing patterns may be used for SSBs 305 and corresponding PDCCH transmissions 310 and PDSCH transmissions 315. The corresponding PDCCH transmissions 310 may include scheduling information for the corresponding PDSCH transmissions 315. The corresponding PDSCH transmissions 315 may include RMSI (e.g., a SIB1) for the cell. A PDSCH transmission 315 which includes RMSI for the cell may be referred to as an RMSI PDSCH transmission. The PDCCH transmission 310 may be associated with Type0 common search space (CSS). A default type0 CSS may be a search space set #0 (SSS0) that is associated with CORESET0. The PDSCH transmissions 315 that conveys the RMSI may be periodically broadcast every 160 ms with repetition up to every 20 ms (the network may determine which of the eight repetitions within every 160 ms RMSI period are transmitted). A downlink control information (DCI) format 1_0 conveyed via the PDCCH transmissions 310 may schedule the corresponding PDSCH transmission 315 that conveys the RMSI. The DCI format 1_0 may include a cyclic redundancy check scrambled by a SI radio network temporary ID (SI-RNTI). The UE 115 may monitor the Type0-CSS for the PDCCH transmissions 310 that conveys the DCI format 1_0 that schedules the PDSCH transmission 315.

In a first multiplexing pattern as shown in the diagram 350, the PDCCH transmission 310 may follow the SSB 305 (e.g., the MIB in the SSB 305 may indicate a later resource for the PDCCH). In a second multiplexing pattern as shown in the diagram 355, the PDCCH transmission 310 may be prior to the SSB 305 and the PDSCH transmission 315 may be frequency division multiplexed with the SSB 305. For example, in the second multiplexing pattern as shown in the diagram 355, the MIB in the SSB 305 may indicate a resource for the PDCCH transmission 310 which is prior in time to the SSB 305. In a third multiplexing pattern as shown in the diagram 360, the PDCCH transmission 310 and the PDSCH transmission 315 may be frequency division multiplexed with the SSB 305. For example, in the third multiplexing pattern as shown in the diagram 360, the MIB in the SSB 305 may indicate a resource for the PDCCH transmission 310 which is overlapping in time with the SSB 305. For example, in the second multiplexing pattern as shown in the diagram 355 and the third multiplexing pattern as shown in the diagram 360, the UE 115 may monitor for the PDCCH transmission 310 and may buffer received PDCCH transmissions, and the SSB 305 may indicate a concurrent or past resource for the PDCCH transmission 310, which the UE 115 may identify in the buffer.

In some examples, the second and third multiplexing patterns may be used in FR2 (e.g., frequency bands from 24.25 GHz to 71.0 GHZ) to reduce broadcast channel overhead due to analog beam constraints by frequency division multiplexing the SSB 305 and the corresponding PDCCH transmission 310 and PDSCH transmission 315 associated with the RMSI. In the second multiplexing pattern as shown in the diagram 355, the PDCCH transmission 310 may be transmitted over one symbol and the PDSCH transmission 315 may be transmitted over two symbols using a 120 kHz subcarrier spacing (SCS). In the second multiplexing pattern as shown in the diagram 355, the two symbols of the PDSCH transmission 315 may be frequency division multiplexed with the four symbols of the SSB where the SSB uses a 240 kHz SCS. In the second multiplexing pattern as shown in the diagram 355, four SSBs may be packed into each slot.

In the third multiplexing pattern as shown in the diagram 360, the PDCCH transmission 310 and the PDSCH transmission 315 may each be transmitted over two symbols using a 120 kHz SCS. In the third multiplexing pattern as shown in the diagram 360, the PDCCH transmission 310 and the PDSCH transmission 315 may be frequency division multiplexed with the four symbols of the SSB where the SSB uses a 120 kHz SCS. In the third multiplexing pattern as shown in the diagram 360, two SSBs may be packed into each slot.

The PDSCH transmission 315 may convey RMSI for the cell. RMSI may include the minimum configuration information for the UE to perform initial access with the cell. The payload of the RMSI may vary from 800 to 1500 bits (e.g., based on the vendor of the network entity 105). For example, Table 1 shows an example of the SIB1 transmission strategy for several example vendors and Table 2 shows an example of the other SI (OSI) strategy for the example vendors. SI blocks (SIBs) other than SIB1 (e.g., other than RMSI) such as SIB2-9 (e.g., OSIBs) may be delivered upon request by a UE 115. OSIBs may be conveyed via a PDSCH transmission 315 scheduled by a PDCCH transmission associated with the Type0A-CSS.

TABLE 1

| | | Modulation and | |
|---|---|---|---|
| | Resource Blocks | Coding Scheme | Transport Block |
| Vendor | (RBs) | (MCS) | (TB) Size (Bytes) |
| Vendor 1 | 16 | 5 | 177 |
| Vendor 2 | 13 | 4 | 123 |
| Vendor 3 | 28 | 0 | 101 |

TABLE 2

| | | | Modulation | Transport |
|---|---|---|---|---|
| | | Resource | and Coding | Block |
| | SIB Mapping | Blocks | Scheme | (TB) Size |
| Vendor | Pattern | (RBs) | (MCS) | (Bytes) |
| Vendor 1 | SIB2 + SIB4 | 4 | 5 | 44 |
| Vendor 1 | SIB5 | 20 | 5 | 225 |
| Vendor 2 | SIB2 + SIB3 + SIB5 | 22 | 0 | 80 |
| Vendor 3 | SIB2 + SIB5 | 12 | 0 | 42 |

The quantity of symbols for the PDSCH transmission 315 that conveys the RMSI may be limited to two symbols in the second and third multiplexing patterns as described herein, which may affect the coverage of the PDSCH transmission 315 that conveys the RMSI. For example, for the second multiplexing pattern with a 1500 bit RMSI payload size and 24 resource blocks (RBs) used to convey the PDSCH transmission 315, the UE 115 may demand a ten dB SNR at 1% block error rate (BLER) in order to decode the RMSI. Thus, even with eight repetitions of the RMSI (e.g., which is the maximum within a 160 ms RMSI periodicity), the UE 115 may demand a −3 dB SNR at 1% BLER in order to decode the RMSI.

Accordingly, the network entity 105 may transmit PDSCH transmissions 315 which convey the same RMSI (e.g., the same RMSI payload) in an RMSI period (e.g., 160 ms in NR) so that the UE 115 may soft combine the RMSI from the different PDSCH transmissions. Given an RMSI periodicity of 160, and given an SSB periodicity of 20 ms, the maximum quantity of RMSI repetitions within a 160 ms RMSI period may be eight. Eight repetitions of RMSI may be insufficient under some conditions. For example, eight repetitions may be insufficient for cell-edge UEs 115. Further, transmission of eight PDSCH transmissions 315 conveying RMSI within each RMSI period (e.g., transmission of a maximum quantity of RMSI repetitions) may involve high energy consumption at the network entity 105. RMSI for a given cell may change infrequently (e.g., may change less frequently than every 160 ms). Further, RMSI may change infrequently. Accordingly, in some examples, as described herein, a UE 115 may reuse a previously decoded RMSI based on version IDs associated with RMSI. Note that the 160 ms default RMSI periodicity assumed here is an example, and the techniques described related to use of version IDs associated with RMSI may be applicable and beneficial even when the default RMSI periodicity is smaller or larger than the 160 ms.

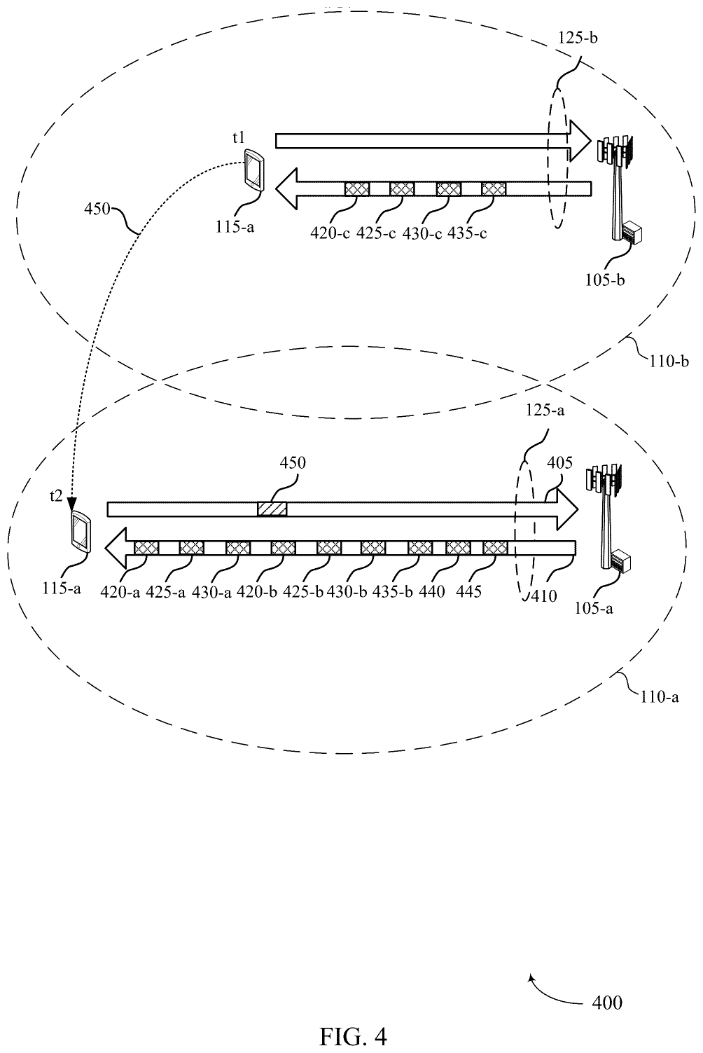

FIG. 4 shows an example of a wireless communications system 400 that supports version IDs for RMSI in accordance with one or more aspects of the present disclosure. The wireless communications system 400 may implement or may be implemented by aspects of the wireless communications system 100. For example, the wireless communications system 400 includes a UE 115-a, a network entity 105-a, and a network entity 105-b which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (e.g., a Uu link). The communication link 125-a may include a bi-directional link that enables both uplink and downlink communication. For example, the UE 115-a may transmit uplink signals 405, such as uplink control signals or uplink data signals, to the network entity 105-a using the communication link 125-a, and the network entity 105-a may transmit downlink signals 410, such as downlink control signals or downlink data signals, to the UE 115-a using the communication link 125-a.

The network entity 105-a may transmit SSBs 420. The SSBs 420 may include a PSS, an SSS, and a PBCH transmission as described herein. The PSS and the SSS of the SSB 420 together may indicate the cell ID, and the UE 115-a also may use the PSS and SSS to synchronize timing with the cell and to decode the PBCH transmission of the SSB 420. The PBCH transmission may convey a MIB which may include SI for the cell and may include scheduling information for a PDCCH occasion to monitor (e.g., may indicate a CORESET and/or a search space to monitor for the PDCCH transmission 425). The PDCCH transmission 425 in the indicated PDCCH occasion may include scheduling information for an RMSI PDSCH transmission 430 (e.g., a PDSCH transmission that includes RMSI). The UE 115-a may use the SSB 420 and the RMSI conveyed via the RMSI PDSCH transmission 430 to perform initial access with the network entity 105-a. For example, the UE 115-a may measure multiple SSBs 420 transmitted by the network entity 105-a, and based on the measurements may select the cell and beam associated with an SSB 420 based on the measurements. The UE may identify a RACH occasion in which to transmit a RACH message 450 (e.g., a msg1 or a msgA) based on the information in the MIB and/or the information in the RMSI conveyed via the RMSI PDSCH transmission 430.

In some examples, the UE may receive an SSB 420-a from the network entity 105-a at a first time which may include a first PBCH transmission which may convey a MIB. The MIB conveyed via the first PBCH transmission may include SI for the cell and may include scheduling information for the PDCCH transmission 425-a. The PDCCH transmission 425-a may include scheduling information for an RMSI PDSCH transmission 430-a. The UE 115-a may successfully decode the RMSI PDSCH transmission 430-a. For example, the UE 115-a may be physically close to (or in coverage range of) the network entity 105-a at the time the UE 115-a decodes the RMSI PDSCH transmission 430-a. The RMSI PDSCH transmission 430-a may include or may indicate a first version ID associated with the RMSI conveyed via the RMSI PDSCH transmission 430-a.

At a second time subsequent to the first time, the UE 115-a may receive an SSB 420-b from the network entity 105-a. For example, the UE 115-a may demand to obtain RMSI at the second time for one or multiple purposes, such as to perform an initial access procedure, cell-reselection, return from out of coverage, after reconfiguration with synchronization completion, after entering the network from another RAT, upon receiving a public warning system (PWS) notification, or if the UE does not have a valid stored SIB (e.g., a SIB1 may not be valid after a duration of time such as 3 hours). The SSB 420-b may include a second PBCH transmission which may convey a MIB. The MIB conveyed via the second PBCH transmission may include SI for the cell and may include scheduling information for the PDCCH transmission 425-a. The PDCCH transmission 425-b may include scheduling information for an RMSI PDSCH transmission 430-b. The MIB conveyed via the second PBCH transmission may indicate a second version ID for the RMSI transmitted by the cell which transmitted the MIB for a given time window. If the second version ID matches a version ID for RMSI that the UE 115-a has previously decoded and has stored in memory of the UE 115-a, the UE 115-a may refrain from monitoring for the PDCCH transmission 425-b and the RMSI PDSCH transmission 430-b. For example, the UE 115-a may use the previously decoded RMSI that matches the second version ID instead of acquiring or decoding the RMSI again. For example, if the second version ID indicated by the MIB in the SSB 420-b matches the first version ID indicated by the RMSI PDSCH transmission 430-a, the UE 115-a may use the RMSI decoded from the RMSI PDSCH transmission 430-a for an initial access procedure with the cell and the UE 115-a may refrain from monitoring for the PDCCH transmission 425-b and the RMSI PDSCH transmission 430-b.

In some examples, the payload of the RMSI may include an indication of the version ID for the RMSI. For example, the payload of the RMSI PDSCH transmission 430-a may include an indication of the first version ID associated for the first RMSI conveyed by the RMSI PDSCH transmission 430-a and the payload of the RMSI PDSCH transmission 430-b may include an indication of the second version ID associated for the second RMSI conveyed by the RMSI PDSCH transmission 430-b. The UE 115-a may store the RMSI associated with a version ID in memory after decoding the RMSI from the corresponding RMSI PDSCH transmission 430. In some examples, the version ID may be represented by X bits for a total of 2× possible RMSI version IDs. The UE 115-a may assume that if two RMSIs are associated with the same version ID, the two RMSIs have identical payloads from the point of view of the UE 115-a, and thus the UE 115-a may refrain from decoding a new RMSI if the UE 115-a has already stored an RMSI associated with the same version ID. From the perspective of the network entity 105-a, a version ID may be reused if the network can ensure that the UE 115-a will not associate two different RMSIs with the same version ID.

The indication in the MIB (e.g., in the SSBs 420) of the version ID associated with the RMSI to be transmitted by the cell which transmitted the MIB may similarly use X bits in the MIB. In some examples, the MIB may use a reduced quantity of bits Z, where Z<X, to indicate the version ID associated with the RMSI to be transmitted by the cell which transmitted the MIB, where the version ID may be obtained based on Mod (Version ID, 2^{Z}). For example, if v₂=v₁ (or v₂=Mod (v₁,Z²)), where v₂ is the version ID indicated in the MIB and v₁ is the version ID associated with a previously decoded RMSI, the UE 115-a may expect the same RMSI is broadcast during a time window associated with the MIB (and thus the UE 115-a may refrain from monitoring for the associated PDCCH transmission 425 and RMSI PDSCH transmission 430). If v₂ does not equal v₁ (or v₂ does not equal Mod (v₁,Z²)), the UE 115-a may attempt to decode the associated PDCCH transmission 425 and RMSI PDSCH transmission 430 to obtain the RMSI associated with the cell that transmitted the MIB. Each MIB in all SSBs in an SSB burst (e.g., SSBs with different transmit beams) may indicate the same RMSI version ID.

In some examples, RMSI received from a first cell may not be used for a second cell. For example, in addition to checking whether the version IDs match, the UE 115-a also may check whether the cell (e.g., PCI) associated with a first RMSI is also associated with the cell (e.g., PCI) associated with the SSB 420 that includes the MIB that indicates the version ID.

For example, the UE 115-a may be located within a coverage area 110-b of a cell associated with a network entity 105-b at a first time, t1, and the UE 115-a may move to the coverage area 110-a of a cell associated with the network entity 105-a at a second time t2. In such examples, the UE 115-a may receive an SSB 420-c, a PDCCH transmission 425-c, and an RMSI PDSCH transmission 430-c from the network entity 105-b via a communication link 125-b while the UE 115-a is within the coverage area 110-b. The RMSI PDSCH transmission 430-c may indicate the version ID v₃. After the UE 115-a moves to the coverage area 110-a at time t2, the UE 115-a may receive the SSB 420-b from the network entity 105-a that indicates the version ID v₂. If the RMSI received from a first cell is not able to be used for a different cell, the UE 115-a may not use the RMSI decoded from the RMSI PDSCH transmission 430-c for initial access to the cell associated with the network entity 105-a even if the version ID v₃ matches the version ID v₂. In such cases, the UE 115-a may attempt to decode the PDCCH transmission 425-b and the RMSI PDSCH transmission 430-b to acquire the RMSI for the cell associated with the network entity 105-a. If RMSI is the same across the cells associated with the network entity 105-b and the network entity 105-a, however, the UE 115-a may use the RMSI decoded from the RMSI PDSCH transmission 430-c for initial access to the cell associated with the network entity 105-a if the version ID v₃ matches the version ID v₂.

In some examples, RMSI may be the same across different cells via moving cell-dependent content of RMSI to subsequent messages (e.g., other SIBs) so that RMSI can be still shared (same payload of RMSI can be assumed subject to matching version IDs) across different cells. The cell dependent content may be PRACH configurations (such as PRACH root sequence), or the “CellAccessRelatedInfo” or the “cellSelectionInfo.” In such examples, cell-dependent content may not be included in the RMSI. For example, the UE 115-a may receive cell-dependent SI from the cell associated with the network entity 105-b via an OSIB 435-c after reception of the RMSI PDSCH transmission 430-c, and the UE 115-a may receive cell-dependent SI from the cell associated with the network entity 105-a via an OSIB 435-b after reception of the RMSI PDSCH transmission 430-b. In some examples, the UE 115-a may transmit a request for the OSIBs 435. Moving the cell dependent content to other SI messages such as the OSIBs 435 may allow the payload of the cell-specific parameters to be lower, thereby enabling cell-edge UEs 115 to decode the cell-specific parameters (e.g., in an OSIB 435), while a cell edge UE 115 may avoid attempting to decode RMSI which the cell edge UE 115 has already successfully decoded from another cell.

In some examples, RMSI may be the same across different cells via conveying cell-dependent content of RMSI through common payload bits in RMSI that are interpreted by the UE 115-a differently depending on the cell. For example, the UE 115-a may interpret the cell-dependent content of RMSI according to a table, where the table may be fixed or may be conveyed through a prior RMSI that the UE 115-a successfully decoded. For example, the table may indicate an interpretation for a given set of bits of the RMSI based on the PCI of the cell. Table 3 shows an example of such a table.

TABLE 3

| | | | |
|---|---|---|---|
| Value | Interpretation | Interpretation | Interpretation |
| of common | if, e.g., | if, e.g., | if, e.g., |
| payload bits | mod(PCI, 3) = 0 | mod(PCI, 3) = 1 | mod(PCI, 3) = 2 |

0
1
2
3
. . .

In some examples, the network entity 105-a may provide an indication of an RMSI version ID for each neighbor cell, for example, as part of a neighbor cell list 440. The indication of the RMSI version ID for each cell may facilitate RMSI sharing across cells such that the UE 115-a may determine whether the UE 115-a should decode a new RMSI when the UE 115-a attempts to connect to a new cell (e.g., a new cell listed in the neighbor cell list 440). In some examples, the UE 115-a may skip checking the RMSI version ID indicated in a MIB for a new cell if the UE 115-a receives an indication of the RMSI version ID for the new cell via the neighbor cell list 440. In some cases, the UE 115-a may assume that RMSI version IDs in a neighbor cell list expire after a given time window (e.g., after which the UE 115-a may check checking the RMSI version ID indicated in a MIB for a new cell if the UE 115-a).

In some examples, the UE 115-a may determine that two cells are different if the cells have different PCIs. In some examples, the UE 115-a may determine that two cells are different if the cells have different frequencies including one or more of: different SSB sync rasters, different carriers, different bands, or different FRs (e.g., FRI and FR2). In some examples, RMSI may be shared across different PCIs in the same carrier. In some examples, RMSI may be shared across different bands in the same FR. In some examples, RMSI may be shared across different FRs. In some examples, RMSI may not be shared across different FRs (e.g., the RMSI version ID space may be different in FRI and FR2).

In some examples, the UE 115-a may receive and store RMSI while in one RRC state. The UE 115-a may subsequently use the stored RMSI while in a different RRC state. For example, the UE 115-a may read the RMSI in the RMSI PDSCH transmission 430-a (e.g., for paging) in one of an RRC_IDLE, an RRC_INACTIVE, or an RRC_CONNECTED state. Subsequently, the UE 115-a may demand to acquire RMSI while in a different RRC state. For example, the UE 115-a may demand to acquire the RMSI while in a different RRC state to perform cell-reselection, to return from out of coverage for the cell, after a reconfiguration with sync completion, after entering the network from another RAT, in response to reception of a PWS notification, or if the UE 115-a does not have a valid stored SIB1 for the cell (e.g., stored RMSI may expire after a given duration, such as three hours). In such cases, the UE 115-a may enter a different RRC state than the RRC state the UE 115-a was in when the UE 115-a received the RMSI PDSCH transmission 430-a. For example, the UE 115-a may receive the RMSI PDSCH transmission 430-a while in the RRC_IDLE state, may enter the RRC_CONNECTED state, and then may enter the RRC_INACTIVE state, at which point the UE 115-a may demand to acquire RMSI and thus may decode the MIB in the SSB 420-b which may indicate the RMSI version ID. As described herein, if the RSI version ID in the MIB in the SSB 420-b matches the RMSI version ID indicated in the RMSI PDSCH transmission 430-a, the UE 115-a may refrain from decoding the PDCCH transmission 425-b and the RMSI PDSCH transmission 430-b. Table 4 shows possible RRC states at the time of decoding the first RMSI and at the time of subsequently decoding a MIB than indicates an RMSI version associated with the cell that transmitted the MIB.

TABLE 4

| | RRC state at the time of | RRC state at the time of |
|---|---|---|
| | decoding first RMSI | decoding MIB |
| Case A | IDLE/INACTIVE | IDLE/INACTIVE |
| Case B | CONNECTED | IDLE/INACTIVE |
| Case C | IDLE/INACTIVE | CONNECTED |
| Case D | CONNECTED | CONNECTED |

In some cases, if the UE 115-a decodes the RMSI PDSCH transmission 430-b (e.g., based on the RMSI version ID v₂ in the MIB in the SSB 420-b not matching the RMSI version ID v₁ indicated in the RMSI PDSCH transmission 430-a), the RMSI PDSCH transmission 430-b may indicate an RMSI version ID v₃ different than the RMSI version ID v₂ in the MIB in the SSB 420-b. In some such examples, the UE 115-a may consider the mismatch between the RMSI version ID v₃ in the RMSI PDSCH transmission 430-b and the RMSI version ID v₂ in the MIB in the SSB 420-b as an error case. In some examples, the UE 115-a may determine that the version ID for the RMSI in the RMSI PDSCH transmission 430-b is the version ID v₃ in the RMSI PDSCH transmission 430-b, and accordingly the UE 115-a may store the decoded RMSI in memory of the UE 115-a in association with the version ID v₃ (e.g., for comparison to future RMSI version IDs indicated in MIBs). For example, if there is a mismatch between the RMSI version ID v₃ in the RMSI PDSCH transmission 430-b and the RMSI version ID v₂ in the MIB in the SSB 420-b, the UE 115-a may trust the RMSI payload of the RMSI PDSCH transmission 430-b which is indicated in the RMSI payload. In some examples, the UE 115-a may determine that the version ID for the RMSI in the RMSI PDSCH transmission 430-b is the version ID v₂ indicated in the MIB in the SSB 420-b (e.g., for comparison to future RMSI version IDs indicated in MIBs).

In some examples, the UE 115-a may store multiple successfully decoded RMSIs in memory of the UE 115-a in association with the correspond RMSI version IDs for the successfully decoded RMSIs. Accordingly, when the UE 115-a demands to acquire a new RMSI for a cell, the UE 115-a may check whether the RMSI version ID for the cell indicated in the MIB matches any of the stored version IDs for the stored successfully decoded RMSIs. The stored multiple successfully decoded RMSIs may be acquired by the UE 115-a over time at different time instances (e.g., from the same or different cells as the UE 115-a moves). In some examples, the UE 115-a may delete stored RMSI after a threshold amount of time (e.g., a threshold amount of minutes, hours, or days) has passed since acquisition of the RMSI or since the RMSI was used (e.g., matched an RMSI version ID in a MIB). In some examples, the UE 115-a may delete a stored RMSI if the quantity of stored RMSIs exceeds a threshold quantity. In some examples, the UE 115-a may delete one or more stored RMSIs based on control signaling 445 received from the network entity 105-a (e.g., while the UE 115-a is in the RRC connected state with the network entity 105-a). For example, the control signaling 445 may indicate a list of RMSI version IDs to delete. In some examples, the UE 115-a may maintain stored RMSIs per FR, per cell, per carrier, or per band. In some examples, RMSI pre-delivery across cells may be implemented. For example, the network entity 105-a may indicate in the control signaling 445 multiple RMSIs with corresponding RMSI version IDs (e.g., for different cells, bands, or FRs), which the UE 115-a may subsequently use if the RMSI version IDs match an RMSI version ID indicated in a MIB. For example, the UE 115-a may be in a low band with good cell coverage and may subsequently move to a different location with poor coverage at high bind. If the UE 115-a was previously provided the RMSI for the high band via the control signaling 445, the UE 115-a may connect via the high band even in the poor coverage scenario using the previously provided RMSI.

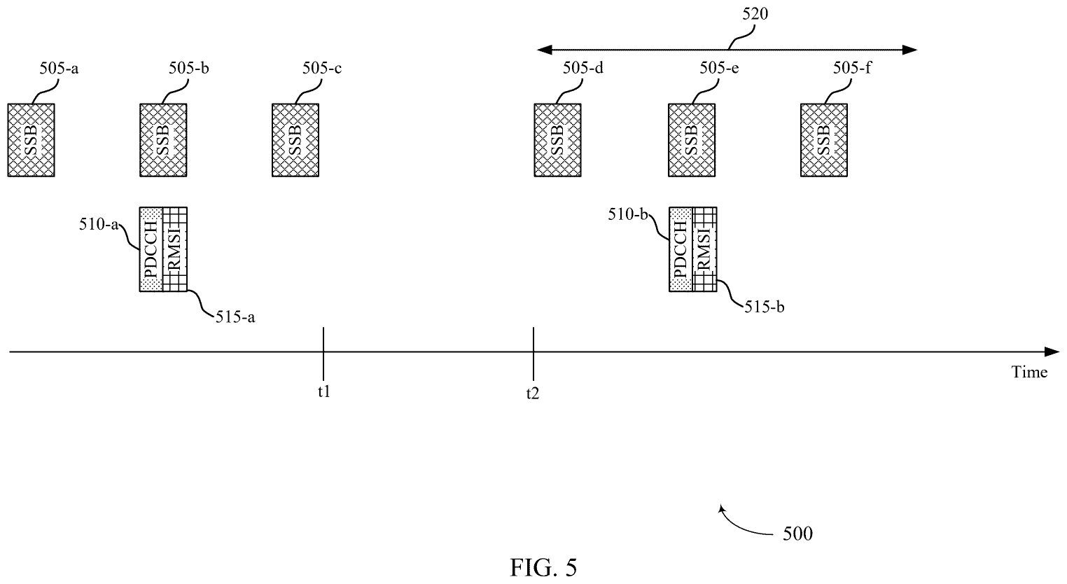

FIG. 5 shows an example of a version ID time window diagram 500 that supports version IDs for RMSI in accordance with one or more aspects of the present disclosure. The version ID time window diagram 500 may implement or may be implemented by aspects of the wireless communications system 100 or the wireless communications system 400.

As described herein, RMSI version IDs may be used to enable a UE 115 to use a previously decoded RMSI (e.g., and refrain from monitoring for RMSI). For example, the UE 115 may receive, while in a first location, a first SSB 505-a, a second SSB 505-b, and a third SSB 505-c. Based on the MIB information, the UE 115 may decode a first RMSI PDSCH transmission 515-a that conveys first RMSI. For example, the MIB in the first SSB 505-a, the second SSB 505-b, or the third SSB 505-c may indicate scheduling information for a PDCCH transmission 510-a, and the PDCCH transmission 510-a may indicate scheduling information for the first RMSI PDSCH transmission 515-a. The first RMSI PDSCH transmission 515-a may indicate a first version ID, v₁, associated with the first RMSI.

Between time t1 and time t2, the UE 115 may physically move (e.g., may move to a different geographic location) and may demand to acquire RMSI (e.g., to access a cell). After the time t2, the UE 115 may receive a fourth SSB 505-d, a fifth SSB 505-c, and a sixth SSB 505-f from a cell. The UE 115 may decode the MIB in the fourth SSB 505-d. The MIB in the fourth SSB 505-d may indicate a version ID, v₂, for RMSI transmitted by the cell which transmitted the fourth SSB 505-d for a time window 520. The MIB in the fourth SSB 505-d may indicate scheduling information for a PDCCH transmission 510-b, and the PDCCH transmission 510-b may indicate scheduling information for the RMSI PDSCH transmission 515-b. If v₁ and v₂ match (e.g., if v₂=v₁ or if v₂=Mod (v₁,Z²)), the UE 115 may refrain from monitoring for RMSI during the time window 520 (e.g., the UE 115 may not monitor for the PDCCH transmission 510-b and the RMSI PDSCH transmission 515-b). If v₁ and v₂ do not match (e.g., if v₂≠v₁ or if v₂≠Mod(v₁,Z²)), the UE 115 may monitor for RMSI during the time window 520 (e.g., the UE 115 may monitor for the PDCCH transmission 510-b and the RMSI PDSCH transmission 515-b).

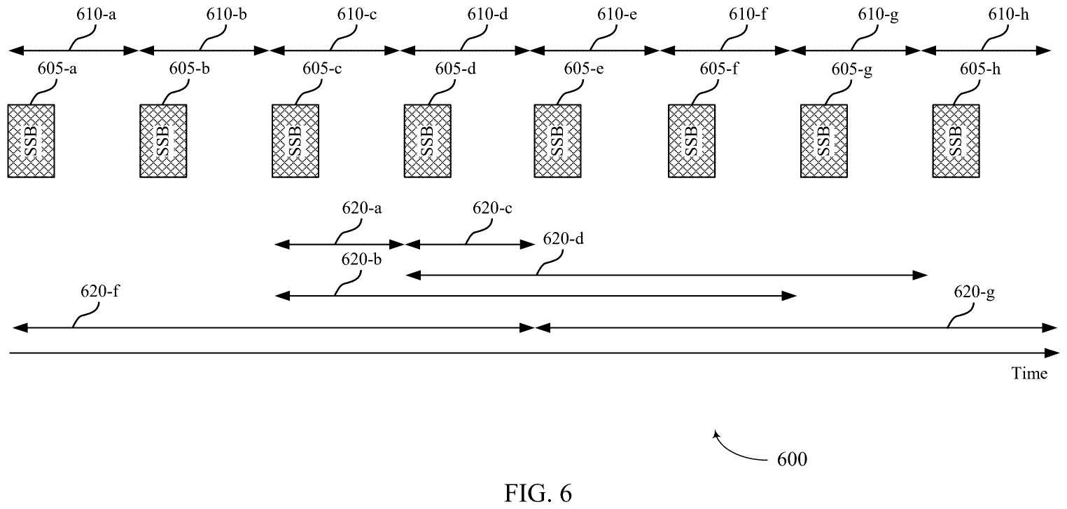

FIG. 6 shows an example of a version ID time window diagram 600 that supports version IDs for RMSI in accordance with one or more aspects of the present disclosure. The version ID time window diagram 600 may implement or may be implemented by aspects of the wireless communications system 100 or the wireless communications system 400.

As described herein, RMSI version IDs may be used to enable a UE 115 to use a previously decoded RMSI (e.g., and refrain from monitoring for RMSI). For example, a cell associated with a network entity 105 may transmit, and a UE 115 may receive, an SSB 605-a in a first SSB period 610-a, an SSB 605-b in a second SSB period 610-b, an SSB 605-c in a third SSB period 610-c, an SSB 605-d in a fourth SSB period 610-d, an SSB 605-e in a fifth SSB period 610-e, an SSB 605-f in a sixth SSB period 610-f, an SSB 605-g in a seventh SSB period 610-g, and an SSB 605-h in an eighth SSB period 610-h. A MIB in an SSB 605 may indicate the version ID associated with RMSI that will be transmitted by the cell which transmitted the SSB 605 for a time window 620 (e.g., the time window 520 as described with reference to FIG. 5). For example, the SSB 605-c may include a MIB which indicates a first version ID, v₁, and the SSB 605-h may include a MIB which indicates a first version ID, v₂.

In some examples, the time window 620 may be a time unit with a starting time as a function of the time at which the SSB 605 is received. For example, the time unit may be an SSB periodicity (e.g., 20 ms), a radio frame (e.g., ten ms), N SSB burst periodicities, or N radio frames. An SSB periodicity may refer to the length of the SSB periods 610. In the case that the unit of the time window 620 is an SSB periodicity, the default SSB periodicity (e.g., 20 ms) may be assumed, or the previous RMSI associated with the same version ID may indicate the SSB periodicity. In some examples, where N>1, N may be predefined or standardized (e.g., N=2, N=4, or N=8). For example, for a transition to a new RMSI, the MIB in an SSB 605 may indicate an invalid version ID (e.g., a reserved value) temporarily (e.g., if within the next eight periodicities (160 ms), the RMSI version actually changes, the MIB in the subsequent seven periodicities may indicate the invalid version ID until the time window maps to the new version ID). In some examples, where N>1, the MIB in the SSB 605 may indicate the value of N (e.g., which may demand a field in the MIB to indicate the value of N).

In some examples, the start time of the time window may be the SSB period 610 or the radio frame that includes the SSB which includes the MIB. For example, the time window 620-a shows an example where the time window 620-a for the version ID Vi indicated in the SSB 605-c starts at the beginning of the third SSB period 610-c in which the SSB 605-c is received, where N=1. As another example, the time window 620-b shows an example where the time window 620-b for the version ID v₁ indicated in the SSB 605-c starts at the beginning of the third SSB period 610-c in which the SSB 605-c is received, where N=4. In some examples, the start time of the time window may be the SSB period 610 or the radio frame that includes the SSB which follows the MIB. For example, the time window 620-c shows an example where the time window 620-c for the version ID v₁ indicated in the SSB 605-c starts at the beginning of the fourth SSB period 610-d, which is after the third SSB period 610-c in which the SSB 605-c is received, where N=1. As another example, the time window 620-d shows an example where the time window 620-d for the version ID v₁ indicated in the SSB 605-c starts at the beginning of the fourth SSB period 610-d, which is after the third SSB period 610-c in which the SSB 605-c is received, where N=4.

In some examples, the time window 620 may be a time unit that includes the time or the SFN in which the SSB 605 which includes the MIB that indicates the version ID is received. In such examples, the starting time may not move with the SSB 605. Accordingly, the same version ID may be indicated in all SSBs sent during that time unit, allowing for soft combining of the MIB within the time unit. In such examples, the time window 620 may be represented by the SEN as the time window 620 may not be floating. The SFN of an SSB 605 may be obtained from the MIB in the SSB 605. For example, assuming the SFN of an SSB 605 is s, the time unit for the time window 620 may be N radio frames with

$$SFNs \{ ⌊ \frac{s}{N} ⌋ N , ⌊ \frac{s}{N} ⌋ N + 1 , … , ⌊ \frac{s}{N} ⌋ N + N - 1 \} .$$

For example, the time window 620-f may include the SSB 605-a, the SSB 605-b, the SSB 605-c, and the SSB 605-d, and each of the SSB 605-a, the SSB 605-b, the SSB 605-c, and the SSB 605-d may indicate the same version ID (e.g., v₁). Similarly, the time window 620-g may include the SSB 605-e, the SSB 605-f, the SSB 605-g, and the SSB 605-h, and each of the SSB 605-c, the SSB 605-f, the SSB 605-g, and the SSB 605-h may indicate the same version ID (e.g., v₂). As shown N=8 for the time window 620-f and the time window 620-g (e.g., eight different ten ms radio frames). In some examples, N may be predefined or standardized (e.g., N=2, N=4, or N=8), and use of a reserved version ID to indicate a transition may not be used as each SSB in the time window 620 may indicate the same version ID. In some examples, some examples, N may be indicated by the MIB. Soft combining the MIBs in a same window may be possible as each MIB in the same time window may indicate the same version ID. In some examples, N can be the RMSI periodicity. For example, for a fixed N, the value of N may be the same as the NR RMSI periodicity (e.g., N=16 for a 160 ms RMSI periodicity). As another example, in the case where the MIB indicates N, the MIB may indicate the RMSI periodicity.

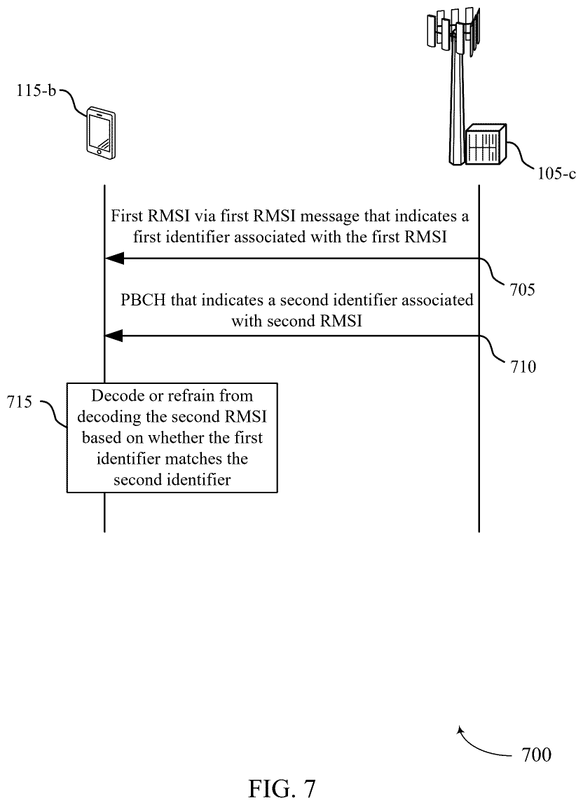

FIG. 7 shows an example of a process flow 700 that supports version IDs for RMSI in accordance with one or more aspects of the present disclosure. The process flow 700 may include a UE 115-b and a network entity 105-c, which may be examples of a UE 115 and a network entity 105 as described herein. In the following description of the process flow 700, the communications between the network entity 105-c and the UE 115-b may be transmitted in a different order than the example order shown, or the operations performed by the network entity 105-c and the UE 115-b may be performed in different orders or at different times. Some operations may also be omitted from the process flow 700, and other operations may be added to the process flow 700.

At 705, the network entity 105-c may transmit, and the UE 115-b may receive, first RMSI via a first RMSI message. The first RMSI message may indicate a first ID (e.g., first version ID) associated with the first RMSI.

At 710, the network entity 105-c may transmit, and the UE 115-b may receive from a cell associated with the network entity 105-b, after the first RMSI message, a PBCH transmission that indicates a second ID (e.g., second version ID) associated with second RMSI associated with the cell during a time window.

At 715, the UE 115-b may select to decode or refrain from decoding a second RMSI message associated with the cell during the time window based on whether the first ID matches the second ID.

In some examples, at 715, the UE 115-b may select to refrain from decoding the second RMSI message based on the first ID matching the second ID, where the first ID matching the second ID is indicative that the first RMSI is the same as the second RMSI. In some such examples, the UE 115-b may receive, from a second cell and prior to the time window, one or more first additional SI messages (e.g., OSIBs) that include first cell-specific information associated with the second cell, the first RMSI message may be received from the second cell, and the first RMSI message may include information common to the second cell and the cell. In such examples, the UE 115-b may receive, from the cell associated with the network entity 105-c and after the PBCH transmission, one or more second additional SI messages that include second cell-specific information associated with the cell. In some examples, the UE 115-b may receive the first RMSI message at 705 from a second cell associated with the network entity 105-c, the first RMSI may include a set of bits, and the interpretation of the set of bits may be cell-dependent.

In some examples, at 715, the UE 115-b may select to decode the second RMSI message based on the first ID having a different value than (e.g., not matching) the second ID, where the first ID having the different value than the second ID is indicative that the first RMSI is different than the second RMSI. In some examples, the second RMSI message may include an indication of the second ID associated with the second RMSI. In some examples, the second RMSI message may include an indication of a third ID different than the second ID, and the UE 115-b may determine that the second RMSI is associated with the third ID. In some examples, the second RMSI message may include an indication of a third ID different than the second ID, and the UE 115-b may determine that the second RMSI is associated with the second ID.

In some examples, a temporal beginning of the time window may be based on a reception time of the PBCH transmission.

In some examples, the time window may be a fixed quantity of radio frames.

In some examples, the PBCH transmission may include an indication of the quantity of radio frames included in the time window. In some examples, the network entity 105-c may transmit, and the UE 115-b may receive from the cell associated with the network entity 105-c, during the time window, a second PBCH transmission that indicates the second ID associated with the second RMSI, and the second PBCH may indicate the quantity of radio frames included in the time window.

In some examples, at 715 the UE 115-b may decode the second RMSI message based on the first RMSI message being received from a second cell different than the cell.

In some examples, the UE 115-b may receive the first RMSI message while in a first RRC state, and the UE 115-b may receive the PBCH while in a second RRC state different than the first RRC state.

In some examples, the network entity 105-c may transmit, and the UE 115-b may receive a control message that indicates a list of neighbor cells and a respective ID associated with RMSI for each neighbor cell.

In some examples, the UE 115-b may delete the first RMSI from memory of the UE 115-b based on a duration since reception of the first RMSI message, a quantity of RMSI messages stored in memory of the UE exceeding a threshold, control signaling received from the cell or a second cell indicating to delete the first RMSI, or a combination thereof.

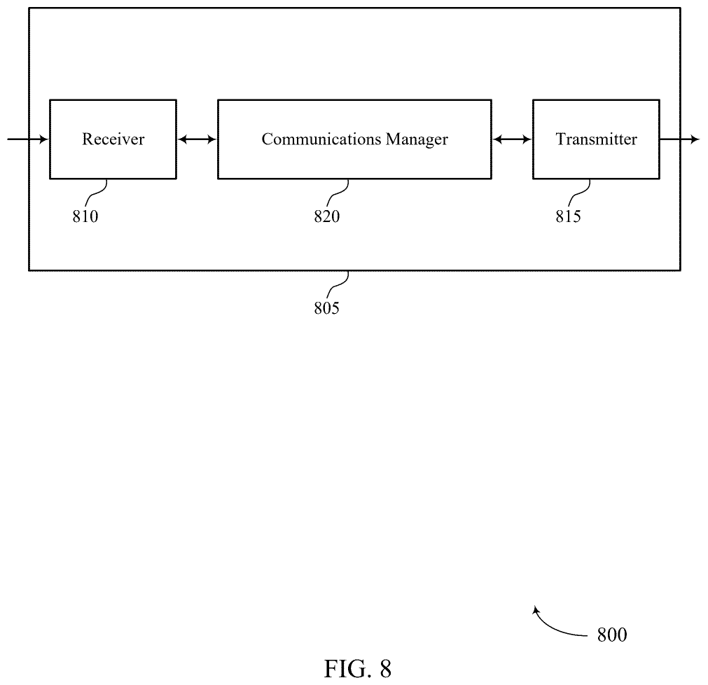

FIG. 8 shows a block diagram 800 of a device 805 that supports version IDs for RMSI in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to version IDs for RMSI). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to version IDs for RMSI). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of version IDs for RMSI as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first RMSI via a first RMSI message, where the first RMSI message indicates a first ID associated with the first RMSI. The communications manager 820 is capable of, configured to, or operable to support a means for receiving, from a cell and after the first RMSI message, a PBCH transmission that indicates a second ID associated with second RMSI associated with the cell during a time window. The communications manager 820 is capable of, configured to, or operable to support a means for selecting to decode or refrain from decoding a second RMSI message associated with the cell during the time window based on whether the first ID matches the second ID.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

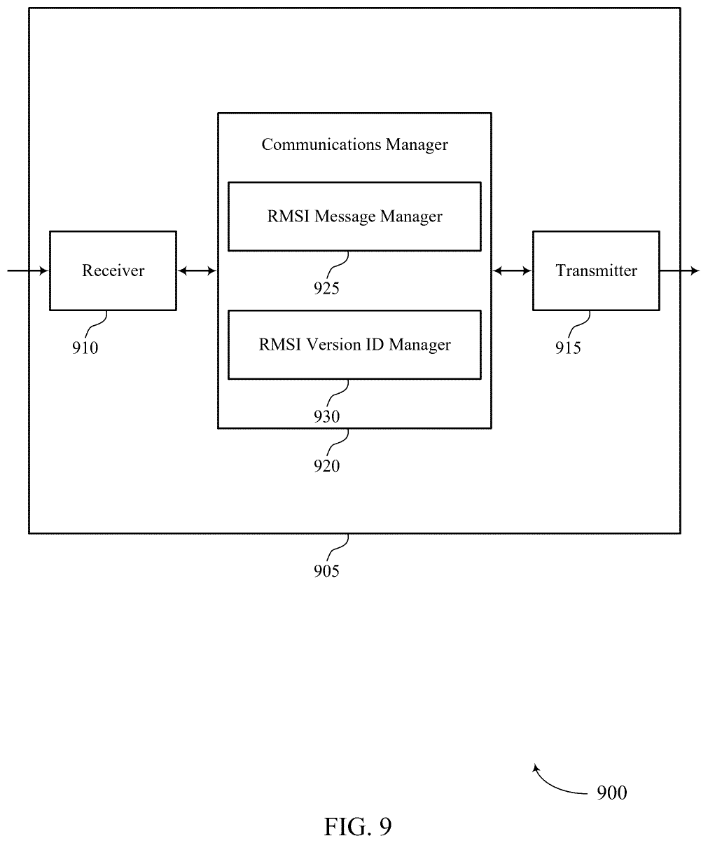

FIG. 9 shows a block diagram 900 of a device 905 that supports version IDs for RMSI in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to version IDs for RMSI). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to version IDs for RMSI). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of version IDs for RMSI as described herein. For example, the communications manager 920 may include an RMSI message manager 925 an RMSI version ID manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The RMSI message manager 925 is capable of, configured to, or operable to support a means for receiving first RMSI via a first RMSI message, where the first RMSI message indicates a first ID associated with the first RMSI. The RMSI message manager 925 is capable of, configured to, or operable to support a means for receiving, from a cell and after the first RMSI message, a PBCH transmission that indicates a second ID associated with second RMSI associated with the cell during a time window. The RMSI version ID manager 930 is capable of, configured to, or operable to support a means for selecting to decode or refrain from decoding a second RMSI message associated with the cell during the time window based on whether the first ID matches the second ID.

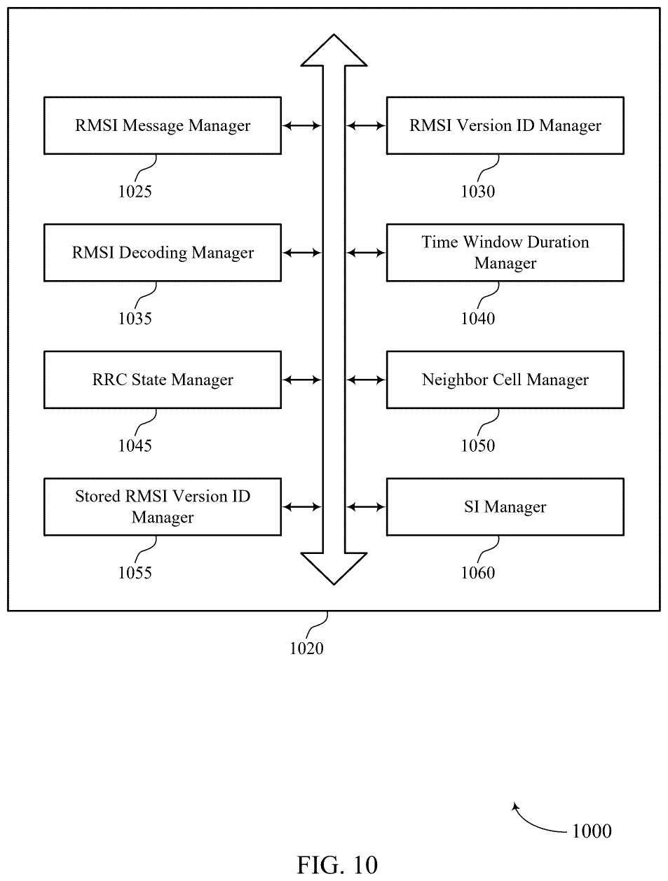

FIG. 10 shows a block diagram 1000 of a communications manager 1020 that supports version IDs for RMSI in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of version IDs for RMSI as described herein. For example, the communications manager 1020 may include an RMSI message manager 1025, an RMSI version ID manager 1030, an RMSI decoding manager 1035, a time window duration manager 1040, an RRC state manager 1045, a neighbor cell manager 1050, a stored RMSI version ID manager 1055, an SI manager 1060, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The RMSI message manager 1025 is capable of, configured to, or operable to support a means for receiving first RMSI via a first RMSI message, where the first RMSI message indicates a first ID associated with the first RMSI. In some examples, the RMSI message manager 1025 is capable of, configured to, or operable to support a means for receiving, from a cell and after the first RMSI message, a PBCH transmission that indicates a second ID associated with second RMSI associated with the cell during a time window. The RMSI version ID manager 1030 is capable of, configured to, or operable to support a means for selecting to decode or refrain from decoding a second RMSI message associated with the cell during the time window based on whether the first ID matches the second ID.

In some examples, to support selecting to decode or refrain from decoding the second RMSI message, the RMSI version ID manager 1030 is capable of, configured to, or operable to support a means for selecting to refrain from decoding the second RMSI message based on the first ID matching the second ID, where the first ID matching the second ID is indicative that the first RMSI is a same as the second RMSI.

In some examples, the SI manager 1060 is capable of, configured to, or operable to support a means for receiving, from a second cell and prior to the time window, one or more first additional SI messages that include first cell-specific information associated with the second cell, where the first RMSI message is received from the second cell, and where the first RMSI message includes information common to the second cell and the cell. In some examples, the SI manager 1060 is capable of, configured to, or operable to support a means for receiving, from the cell and after the PBCH transmission, one or more second additional SI messages that include second cell-specific information associated with the cell.

In some examples, to support receiving the first RMSI message, the RMSI message manager 1025 is capable of, configured to, or operable to support a means for receiving the first RMSI message from a second cell, where the first RMSI message includes a set of bits, where an interpretation of the set of bits is cell-dependent.

In some examples, to support selecting to decode or refrain from decoding the second RMSI message, the RMSI decoding manager 1035 is capable of, configured to, or operable to support a means for selecting to decode the second RMSI message based on the first ID having a different value than the second ID, where the first ID having the different value than the second ID is indicative that the first RMSI is different than the second RMSI.

In some examples, the second RMSI message includes an indication of the second ID associated with the second RMSI.

In some examples, the second RMSI message includes an indication of a third ID different than the second ID, and the RMSI version ID manager 1030 is capable of, configured to, or operable to support a means for determining, based on the third ID having a different value than the second ID, that the second RMSI is associated with the third ID.

In some examples, the second RMSI message includes an indication of a third ID different than the second ID, and the RMSI version ID manager 1030 is capable of, configured to, or operable to support a means for determining, based on the third ID having a different value than the second ID, that the second RMSI is associated with the second ID.

In some examples, a temporal beginning of the time window is based on a reception time of the PBCH transmission.

In some examples, to support receiving the PBCH transmission, the time window duration manager 1040 is capable of, configured to, or operable to support a means for receiving an indication of a duration of the time window.

In some examples, the time window includes a fixed quantity of radio frames.

In some examples, to support receiving the PBCH transmission, the time window duration manager 1040 is capable of, configured to, or operable to support a means for receiving an indication a quantity of radio frames included in the time window.

In some examples, the RMSI version ID manager 1030 is capable of, configured to, or operable to support a means for receiving, from the cell and during the time window, a second PBCH transmission that indicates the second ID associated with the second RMSI, where the second PBCH transmission indicates the quantity of radio frames included in the time window.

In some examples, to support selectively decoding or refraining from decoding the second RMSI message, the RMSI decoding manager 1035 is capable of, configured to, or operable to support a means for decoding the second RMSI message based on the first RMSI message being received from a second cell different than the cell.

In some examples, to support receiving the first RMSI message, the RRC state manager 1045 is capable of, configured to, or operable to support a means for receiving the first RMSI message while in a first RRC state, and where receiving the PBCH transmission includes receiving the PBCH transmission while in a second RRC state different than the first RRC state.

In some examples, the neighbor cell manager 1050 is capable of, configured to, or operable to support a means for receiving, from the cell, a control message that indicates a list of neighbor cells and a respective ID associated with RMSI for each neighbor cell.

In some examples, the stored RMSI version ID manager 1055 is capable of, configured to, or operable to support a means for deleting the first RMSI from memory of the UE based on a duration since reception of the first RMSI message, a quantity of RMSI messages stored in memory of the UE exceeding a threshold, control signaling received from the cell or a second cell indicating to delete the first RMSI, or a combination thereof.

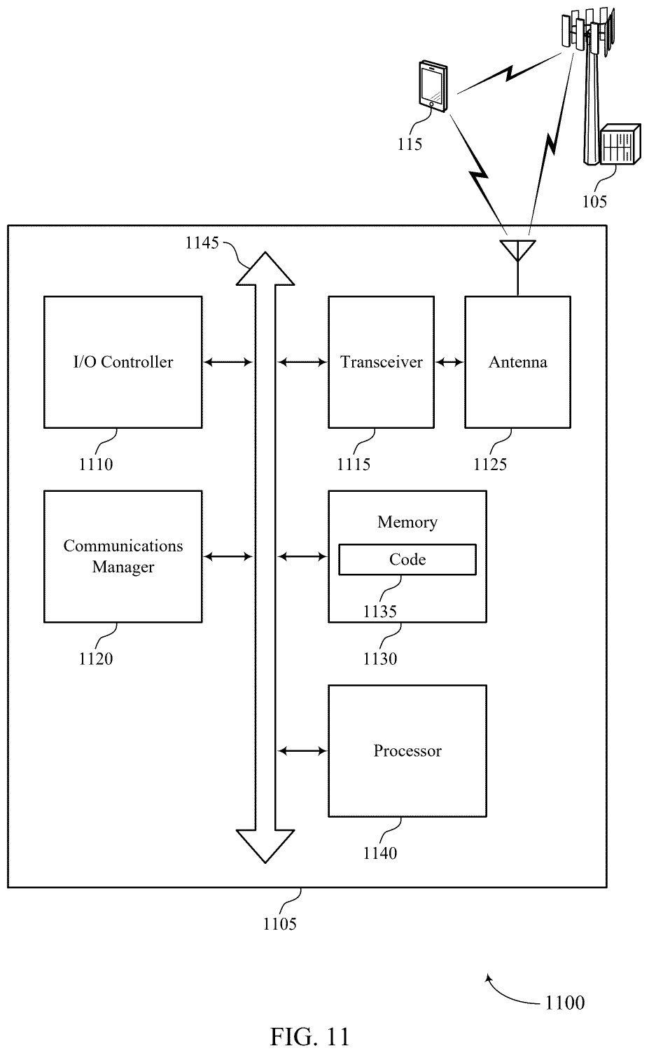

FIG. 11 shows a diagram of a system 1100 including a device 1105 that supports version IDs for RMSI in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting version IDs for RMSI). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first RMSI via a first RMSI message, where the first RMSI message indicates a first ID associated with the first RMSI. The communications manager 1120 is capable of, configured to, or operable to support a means for receiving, from a cell and after the first RMSI message, a PBCH transmission that indicates a second ID associated with second RMSI associated with the cell during a time window. The communications manager 1120 is capable of, configured to, or operable to support a means for selecting to decode or refrain from decoding a second RMSI message associated with the cell during the time window based on whether the first ID matches the second ID.

By including or configuring the communications manager 1120 in accordance with examples as described herein, the device 1105 may support techniques for improved communication reliability, reduced latency, reduced power consumption, more efficient utilization of communication resources, improved coordination between devices, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of version IDs for RMSI as described herein, or the at least one processor 1140 and the at least one memory 1130 may be otherwise configured to, individually or collectively, perform or support such operations.

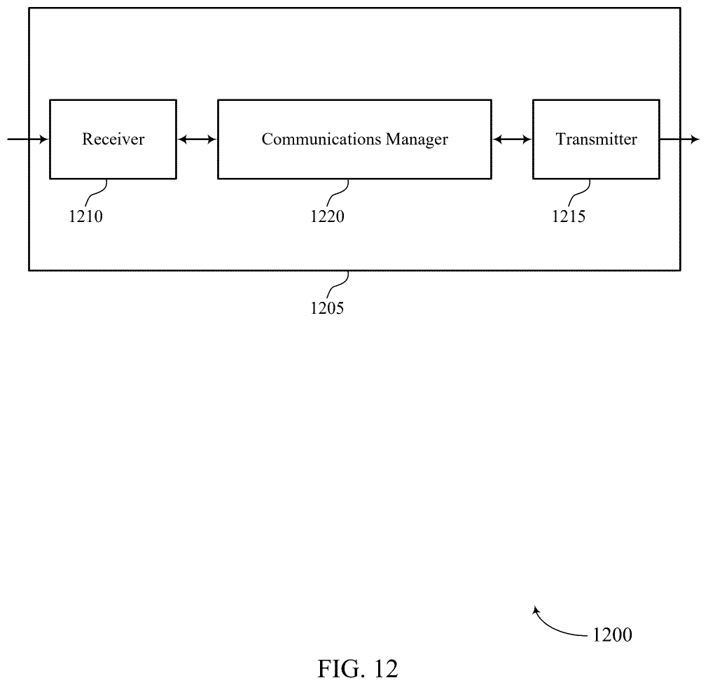

FIG. 12 shows a block diagram 1200 of a device 1205 that supports version IDs for RMSI in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of version IDs for RMSI as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for outputting, to a UE, first RMSI via a first RMSI message associated with a cell, where the first RMSI message indicates a first ID associated with the first RMSI, and where the cell is associated with the network entity. The communications manager 1220 is capable of, configured to, or operable to support a means for outputting, to the UE and after the first RMSI message, a PBCH transmission that indicates a second ID associated with second RMSI associated with the cell during a time window.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources.

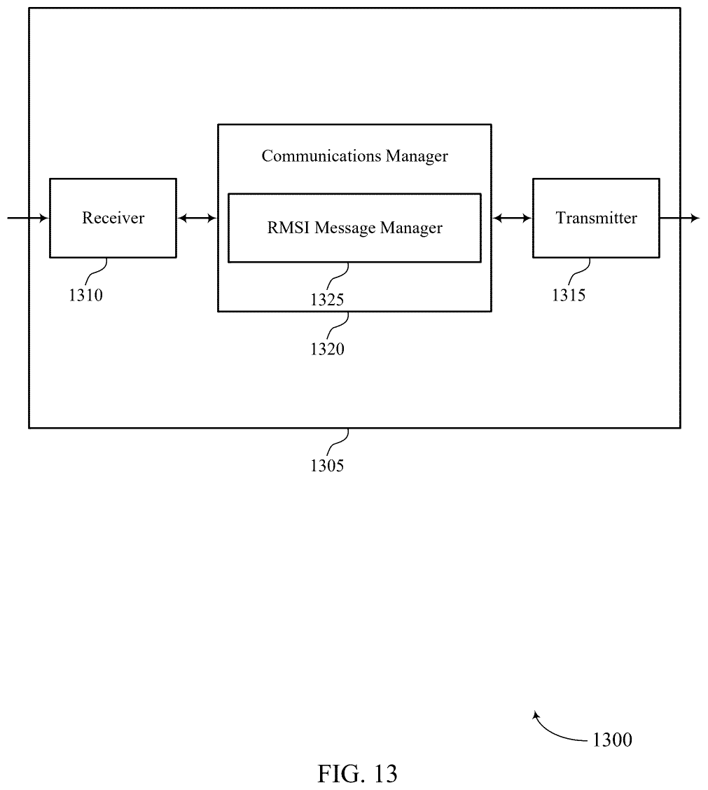

FIG. 13 shows a block diagram 1300 of a device 1305 that supports version IDs for RMSI in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of version IDs for RMSI as described herein. For example, the communications manager 1320 may include an RMSI message manager 1325, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The RMSI message manager 1325 is capable of, configured to, or operable to support a means for outputting, to a UE, first RMSI via a first RMSI message associated with a cell, where the first RMSI message indicates a first ID associated with the first RMSI, and where the cell is associated with the network entity. The RMSI message manager 1325 is capable of, configured to, or operable to support a means for outputting, to the UE and after the first RMSI message, a PBCH transmission that indicates a second ID associated with second RMSI associated with the cell during a time window.

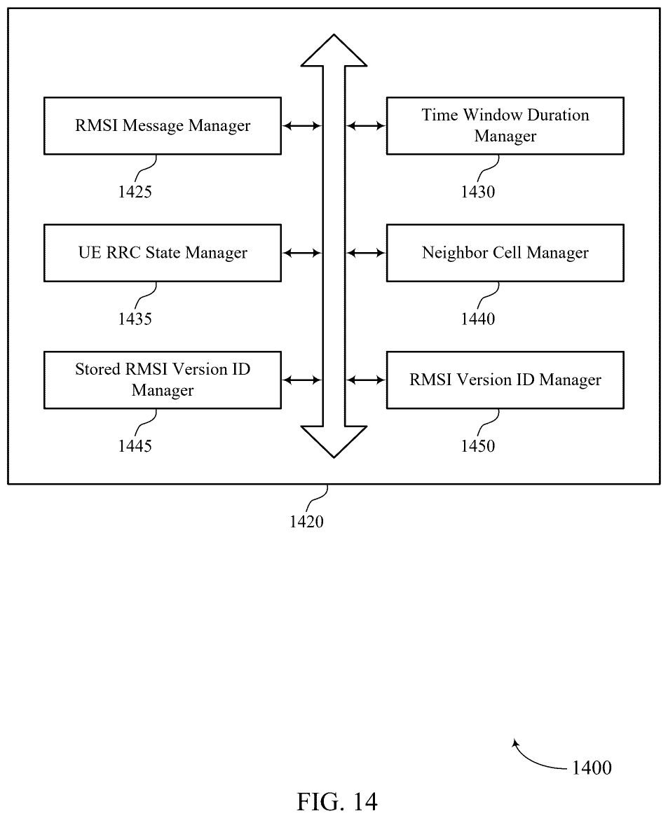

FIG. 14 shows a block diagram 1400 of a communications manager 1420 that supports version IDs for RMSI in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of version IDs for RMSI as described herein. For example, the communications manager 1420 may include an RMSI message manager 1425, a time window duration manager 1430, a UE RRC state manager 1435, a neighbor cell manager 1440, a stored RMSI version ID manager 1445, an RMSI version ID manager 1450, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The RMSI message manager 1425 is capable of, configured to, or operable to support a means for outputting, to a UE, first RMSI via a first RMSI message associated with a cell, where the first RMSI message indicates a first ID associated with the first RMSI, and where the cell is associated with the network entity. In some examples, the RMSI message manager 1425 is capable of, configured to, or operable to support a means for outputting, to the UE and after the first RMSI message, a PBCH transmission that indicates a second ID associated with second RMSI associated with the cell during a time window.

In some examples, the first ID matches the second ID. In some examples, the first ID matching the second ID is indicative that the first RMSI message is a same as the second RMSI.

In some examples, the first ID has a different value than the second ID. In some examples, the first ID having a different value than the second ID is indicative that the first RMSI message is different than the second RMSI.

In some examples, a temporal beginning of the time window is based on a transmission time of the PBCH transmission.

In some examples, to support outputting the PBCH transmission, the time window duration manager 1430 is capable of, configured to, or operable to support a means for outputting an indication of a duration of the time window.

In some examples, the time window includes a fixed quantity of radio frames.

In some examples, to support outputting the PBCH transmission, the time window duration manager 1430 is capable of, configured to, or operable to support a means for outputting an indication a quantity of radio frames included in the time window.

In some examples, the RMSI version ID manager 1450 is capable of, configured to, or operable to support a means for outputting, to the UE and during the time window, a second PBCH transmission that indicates the second ID associated with the second RMSI, where the second PBCH transmission indicates the quantity of radio frames included in the time window.

In some examples, the UE RRC state manager 1435 is capable of, configured to, or operable to support a means for outputting the first RMSI message while the UE is in a first RRC state, and where outputting the PBCH transmission includes outputting the PBCH transmission while the UE is in a second RRC state different than the first RRC state.

In some examples, the neighbor cell manager 1440 is capable of, configured to, or operable to support a means for outputting, to the UE, a control message that indicates a list of neighbor cells and a respective ID associated with RMSI for each neighbor cell.

In some examples, the stored RMSI version ID manager 1445 is capable of, configured to, or operable to support a means for outputting, to the UE, control signaling that indicates to delete the first RMSI.

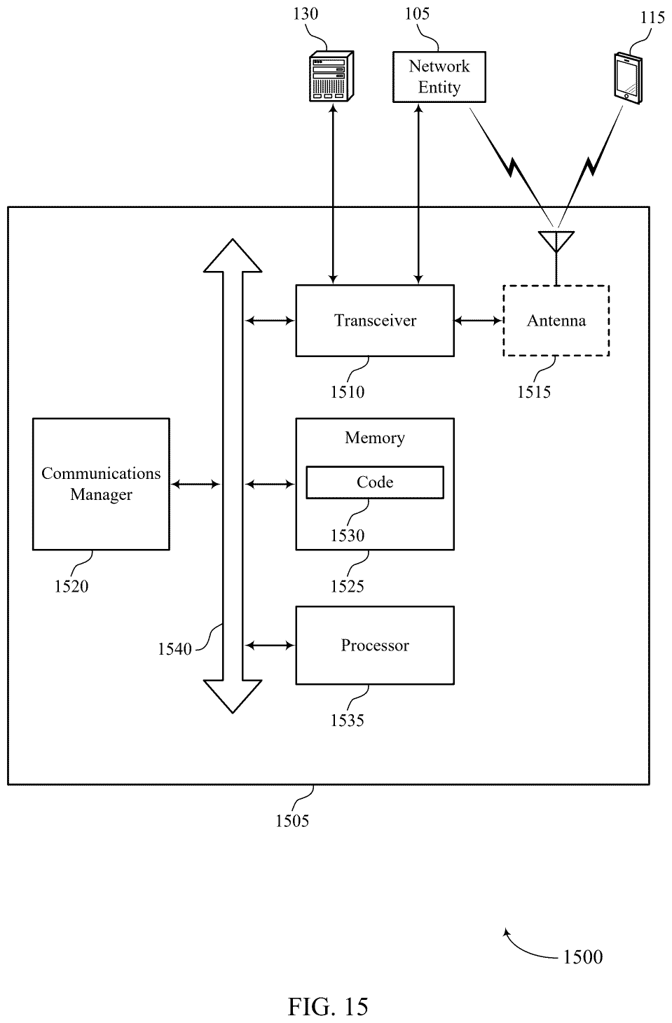

FIG. 15 shows a diagram of a system 1500 including a device 1505 that supports version IDs for RMSI in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting version IDs for RMSI). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for outputting, to a UE, first RMSI via a first RMSI message associated with a cell, where the first RMSI message indicates a first ID associated with the first RMSI, and where the cell is associated with the network entity. The communications manager 1520 is capable of, configured to, or operable to support a means for outputting, to the UE and after the first RMSI message, a PBCH transmission that indicates a second ID associated with second RMSI associated with the cell during a time window.

By including or configuring the communications manager 1520 in accordance with examples as described herein, the device 1505 may support techniques for improved communication reliability, reduced latency, reduced power consumption, more efficient utilization of communication resources, improved coordination between devices, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of version IDs for RMSI as described herein, or the at least one processor 1535 and the at least one memory 1525 may be otherwise configured to, individually or collectively, perform or support such operations.

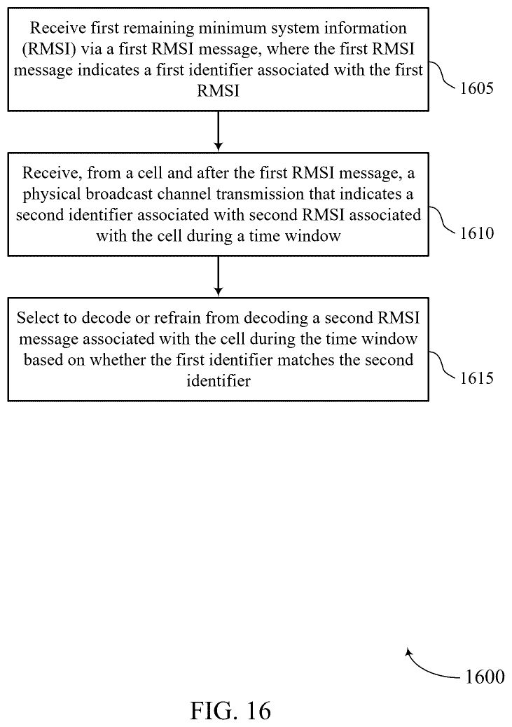

FIG. 16 shows a flowchart illustrating a method 1600 that supports version IDs for RMSI in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving first RMSI via a first RMSI message, where the first RMSI message indicates a first ID associated with the first RMSI. The operations of 1605 may be performed in accordance with examples as disclosed herein. In some examples, aspects of the operations of 1605 may be performed by an RMSI message manager 1025 as described with reference to FIG. 10.

At 1610, the method may include receiving, from a cell and after the first RMSI message, a PBCH transmission that indicates a second ID associated with second RMSI associated with the cell during a time window. The operations of 1610 may be performed in accordance with examples as disclosed herein. In some examples, aspects of the operations of 1610 may be performed by an RMSI message manager 1025 as described with reference to FIG. 10.

At 1615, the method may include selecting to decode or refrain from decoding a second RMSI message associated with the cell during the time window based on whether the first ID matches the second ID. The operations of 1615 may be performed in accordance with examples as disclosed herein. In some examples, aspects of the operations of 1615 may be performed by an RMSI version ID manager 1030 as described with reference to FIG. 10.

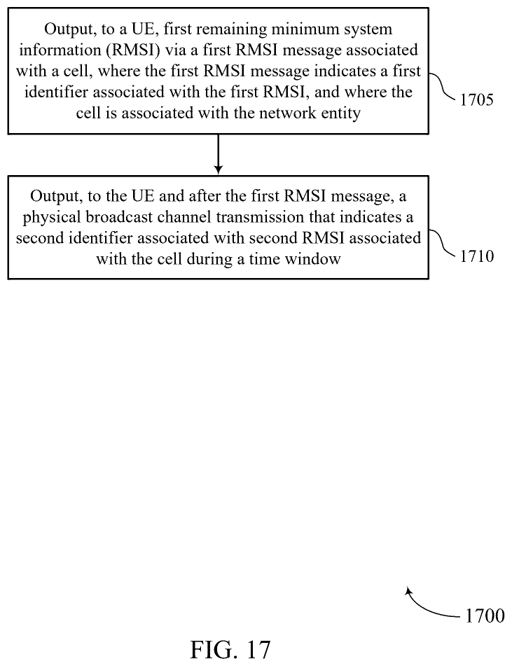

FIG. 17 shows a flowchart illustrating a method 1700 that supports version IDs for RMSI in accordance with one or more aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, first RMSI via a first RMSI message associated with a cell, where the first RMSI message indicates a first ID associated with the first RMSI, and where the cell is associated with the network entity. The operations of 1705 may be performed in accordance with examples as disclosed herein. In some examples, aspects of the operations of 1705 may be performed by an RMSI message manager 1425 as described with reference to FIG. 14.

At 1710, the method may include outputting, to the UE and after the first RMSI message, a PBCH transmission that indicates a second ID associated with second RMSI associated with the cell during a time window. The operations of 1710 may be performed in accordance with examples as disclosed herein. In some examples, aspects of the operations of 1710 may be performed by an RMSI message manager 1425 as described with reference to FIG. 14.

The following provides an overview of aspects of the present disclosure:

Aspect 1: A method for wireless communications at a UE, comprising: receiving first RMSI via a first RMSI message, wherein the first RMSI message indicates a first ID associated with the first RMSI; receiving, from a cell and after the first RMSI message, a PBCH transmission that indicates a second ID associated with second RMSI associated with the cell during a time window; and selecting to decode or refrain from decoding a second RMSI message associated with the cell during the time window based at least in part on whether the first ID matches the second ID.

Aspect 2: The method of aspect 1, wherein selecting to decode or refrain from decoding the second RMSI message comprises: selecting to refrain from decoding the second RMSI message based at least in part on the first ID matching the second ID, wherein the first ID matching the second ID is indicative that the first RMSI is a same as the second RMSI.

Aspect 3: The method of aspect 2, further comprising: receiving, from a second cell and prior to the time window, one or more first additional SI messages that comprise first cell-specific information associated with the second cell, wherein the first RMSI message is received from the second cell, and wherein the first RMSI message comprises information common to the second cell and the cell; and receiving, from the cell and after the PBCH transmission, one or more second additional SI messages that comprise second cell-specific information associated with the cell.

Aspect 4: The method of any of aspects 2 through 3, wherein receiving the first RMSI message comprises: receiving the first RMSI message from a second cell, wherein the first RMSI message comprises a set of bits, wherein an interpretation of the set of bits is cell-dependent.

Aspect 5: The method of aspect 1, wherein selecting to decode or refrain from decoding the second RMSI message comprises: selecting to decode the second RMSI message based at least in part on the first ID having a different value than the second ID, wherein the first ID having the different value than the second ID is indicative that the first RMSI is different than the second RMSI.

Aspect 6: The method of aspect 5, wherein the second RMSI message includes an indication of the second ID associated with the second RMSI.

Aspect 7: The method of aspect 5, wherein the second RMSI message includes an indication of a third ID different than the second ID, the method further comprising: determining, based at least in part on the third ID having the different value than the second ID, that the second RMSI is associated with the third ID.

Aspect 8: The method of aspect 5, wherein the second RMSI message includes an indication of a third ID different than the second ID, the method further comprising: determining, based at least in part on the third ID having the different value than the second ID, that the second RMSI is associated with the second ID.

Aspect 9: The method of any of aspects 1 through 8, wherein a temporal beginning of the time window is based at least in part on a reception time of the PBCH transmission.

Aspect 10: The method of any of aspects 1 through 9, wherein receiving the PBCH transmission comprises: receiving an indication of a duration of the time window.

Aspect 11: The method of any of aspects 1 through 10, wherein the time window comprises a fixed quantity of radio frames.

Aspect 12: The method of any of aspects 1 through 11, wherein receiving the PBCH transmission comprises: receiving an indication a quantity of radio frames included in the time window.

Aspect 13: The method of aspect 12, further comprising: receiving, from the cell and during the time window, a second PBCH transmission that indicates the second ID associated with the second RMSI, wherein the second PBCH transmission indicates the quantity of radio frames included in the time window.

Aspect 14: The method of any of aspects 1 through 13, wherein selectively decoding or refraining from decoding the second RMSI message comprises: decoding the second RMSI message based at least in part on the first RMSI message being received from a second cell different than the cell.

Aspect 15: The method of any of aspects 1 through 14, wherein receiving the first RMSI message comprises: receiving the first RMSI message while in a first RRC state, and wherein receiving the PBCH transmission comprises receiving the PBCH transmission while in a second RRC state different than the first RRC state.

Aspect 16: The method of any of aspects 1 through 15, further comprising: receiving, from the cell, a control message that indicates a list of neighbor cells and a respective ID associated with RMSI for each neighbor cell.

Aspect 17: The method of any of aspects 1 through 16, further comprising: deleting the first RMSI from memory of the UE based at least in part on a duration since reception of the first RMSI message, a quantity of RMSI messages stored in memory of the UE exceeding a threshold, control signaling received from the cell or a second cell indicating to delete the first RMSI, or a combination thereof.

Aspect 18: A method for wireless communications at a network entity, comprising: outputting, to a UE, first RMSI via a first RMSI message associated with a cell, wherein the first RMSI message indicates a first ID associated with the first RMSI, and wherein the cell is associated with the network entity; and outputting, to the UE and after the first RMSI message, a PBCH transmission that indicates a second ID associated with second RMSI associated with the cell during a time window.

Aspect 19: The method of aspect 18, wherein the first ID matches the second ID, and the first ID matching the second ID is indicative that the first RMSI message is a same as the second RMSI.

Aspect 20: The method of aspect 18, wherein the first ID has a different value than the second ID, and the first ID having the different value than the second ID is indicative that the first RMSI message is different than the second RMSI.

Aspect 21: The method of any of aspects 18 through 20, wherein a temporal beginning of the time window is based at least in part on a transmission time of the PBCH transmission.

Aspect 22: The method of any of aspects 18 through 21, wherein outputting the PBCH transmission comprises: outputting an indication of a duration of the time window.

Aspect 23: The method of any of aspects 18 through 22, wherein the time window comprises a fixed quantity of radio frames.

Aspect 24: The method of any of aspects 18 through 23, wherein outputting the PBCH transmission comprises: outputting an indication a quantity of radio frames included in the time window.

Aspect 25: The method of aspect 24, further comprising: outputting, to the UE and during the time window, a second PBCH transmission that indicates the second ID associated with the second RMSI, wherein the second PBCH transmission indicates the quantity of radio frames included in the time window.

Aspect 26: The method of any of aspects 18 through 25, further comprising: outputting the first RMSI message while the UE is in a first RRC state, and wherein outputting the PBCH transmission comprises outputting the PBCH transmission while the UE is in a second RRC state different than the first RRC state.

Aspect 27: The method of any of aspects 18 through 26, further comprising: outputting, to the UE, a control message that indicates a list of neighbor cells and a respective ID associated with RMSI for each neighbor cell.

Aspect 28: The method of any of aspects 18 through 27, further comprising: outputting, to the UE, control signaling that indicates to delete the first RMSI.

Aspect 29: A UE for wireless communications, comprising one or more memories storing processor-executable code, and one or more processors coupled with the one or more memories and individually or collectively operable to execute the code to cause the UE to perform a method of any of aspects 1 through 17.

Aspect 30: A UE for wireless communications, comprising at least one means for performing a method of any of aspects 1 through 17.

Aspect 31: A non-transitory computer-readable medium storing code for wireless communications, the code comprising instructions executable by one or more processors to perform a method of any of aspects 1 through 17.

Aspect 32: A network entity for wireless communications, comprising one or more memories storing processor-executable code, and one or more processors coupled with the one or more memories and individually or collectively operable to execute the code to cause the network entity to perform a method of any of aspects 18 through 28.

Aspect 33: A network entity for wireless communications, comprising at least one means for performing a method of any of aspects 18 through 28.

Aspect 34: A non-transitory computer-readable medium storing code for wireless communications, the code comprising instructions executable by one or more processors to perform a method of any of aspects 18 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first remaining minimum system information (RMSI) via a first RMSI message, wherein the first RMSI message indicates a first identifier associated with the first RMSI;
receive, from a cell and after the first RMSI message, a physical broadcast channel transmission that indicates a second identifier associated with second RMSI associated with the cell during a time window; and
select to decode or refrain from decoding a second RMSI message associated with the cell during the time window based at least in part on whether the first identifier matches the second identifier.

2. The UE of claim 1, wherein, to select to decode or refrain from decoding the second RMSI message, the one or more processors are individually or collectively operable to execute the code to cause the UE to:
select to refrain from decoding the second RMSI message based at least in part on the first identifier matching the second identifier, wherein the first identifier matching the second identifier is indicative that the first RMSI is a same as the second RMSI.

3. The UE of claim 2, wherein the one or more processors are individually or collectively further operable to execute the code to cause the UE to:
receive, from a second cell and prior to the time window, one or more first additional system information messages that comprise first cell-specific information associated with the second cell, wherein the first RMSI message is received from the second cell, and wherein the first RMSI message comprises information common to the second cell and the cell; and
receive, from the cell and after the physical broadcast channel transmission, one or more second additional system information messages that comprise second cell-specific information associated with the cell.

4. The UE of claim 2, wherein, to receive the first RMSI message, the one or more processors are individually or collectively operable to execute the code to cause the UE to:
receive the first RMSI message from a second cell, wherein the first RMSI message comprises a set of bits, wherein an interpretation of the set of bits is cell-dependent.

5. The UE of claim 1, wherein, to select to decode or refrain from decoding the second RMSI message, the one or more processors are individually or collectively operable to execute the code to cause the UE to:
select to decode the second RMSI message based at least in part on the first identifier having a different value than the second identifier, wherein the first identifier having the different value than the second identifier is indicative that the first RMSI is different than the second RMSI.

6. The UE of claim 5, wherein the second RMSI message includes an indication of the second identifier associated with the second RMSI.

7. The UE of claim 5, wherein the second RMSI message includes an indication of a third identifier different than the second identifier, and the one or more processors are individually or collectively further operable to execute the code to cause the UE to:
determine, based at least in part on the third identifier having the different value than the second identifier, that the second RMSI is associated with the third identifier.

8. The UE of claim 5, wherein the second RMSI message includes an indication of a third identifier different than the second identifier, and the one or more processors are individually or collectively further operable to execute the code to cause the UE to:
determine, based at least in part on the third identifier having the different value than the second identifier, that the second RMSI is associated with the second identifier.

9. The UE of claim 1, wherein a temporal beginning of the time window is based at least in part on a reception time of the physical broadcast channel transmission.

10. The UE of claim 1, wherein, to receive the physical broadcast channel transmission, the one or more processors are individually or collectively operable to execute the code to cause the UE to:
receive an indication of a duration of the time window.

11. The UE of claim 1, wherein the time window comprises a fixed quantity of radio frames.

12. The UE of claim 1, wherein, to receive the physical broadcast channel transmission, the one or more processors are individually or collectively operable to execute the code to cause the UE to:
receive an indication a quantity of radio frames included in the time window.

13. The UE of claim 12, wherein the one or more processors are individually or collectively further operable to execute the code to cause the UE to:
receive, from the cell and during the time window, a second physical broadcast channel transmission that indicates the second identifier associated with the second RMSI, wherein the second physical broadcast channel transmission indicates the quantity of radio frames included in the time window.

14. The UE of claim 1, wherein, to selectively decode or refrain from decoding the second RMSI message, the one or more processors are individually or collectively operable to execute the code to cause the UE to:
decode the second RMSI message based at least in part on the first RMSI message being received from a second cell different than the cell.

15. The UE of claim 1, wherein, to receive the first RMSI message, the one or more processors are individually or collectively operable to execute the code to cause the UE to:
receive the first RMSI message while in a first radio resource control state, and wherein receiving the physical broadcast channel transmission comprises receiving the physical broadcast channel transmission while in a second radio resource control state different than the first radio resource control state.

16. The UE of claim 1, wherein the one or more processors are individually or collectively further operable to execute the code to cause the UE to:
receive, from the cell, a control message that indicates a list of neighbor cells and a respective identifier associated with RMSI for each neighbor cell.

17. The UE of claim 1, wherein the one or more processors are individually or collectively further operable to execute the code to cause the UE to:
delete the first RMSI from memory of the UE based at least in part on a duration since reception of the first RMSI message, a quantity of RMSI messages stored in memory of the UE exceeding a threshold, control signaling received from the cell or a second cell indicating to delete the first RMSI, or a combination thereof.

18. A network entity, comprising:
one or more memories storing processor-executable code; and
one or more processors coupled with the one or more memories and individually or collectively operable to execute the code to cause the network entity to:
output, to a user equipment (UE), first remaining minimum system information (RMSI) via a first RMSI message associated with a cell, wherein the first RMSI message indicates a first identifier associated with the first RMSI, and wherein the cell is associated with the network entity; and
output, to the UE and after the first RMSI message, a physical broadcast channel transmission that indicates a second identifier associated with second RMSI associated with the cell during a time window.

19. The network entity of claim 18, wherein:
the first identifier matches the second identifier, and
the first identifier matching the second identifier is indicative that the first RMSI message is a same as the second RMSI.

20. The network entity of claim 18, wherein:
the first identifier has a different value than the second identifier, and
the first identifier having the different value than the second identifier is indicative that the first RMSI message is different than the second RMSI.

21. The network entity of claim 18, wherein a temporal beginning of the time window is based at least in part on a transmission time of the physical broadcast channel transmission.

22. The network entity of claim 18, wherein, to output the physical broadcast channel transmission, the one or more processors are individually or collectively operable to execute the code to cause the network entity to:
output an indication of a duration of the time window.

23. The network entity of claim 18, wherein the time window comprises a fixed quantity of radio frames.

24. The network entity of claim 18, wherein, to output the physical broadcast channel transmission, the one or more processors are individually or collectively operable to execute the code to cause the network entity to:
output an indication a quantity of radio frames included in the time window.

25. The network entity of claim 24, wherein the one or more processors are individually or collectively further operable to execute the code to cause the network entity to:
output, to the UE and during the time window, a second physical broadcast channel transmission that indicates the second identifier associated with the second RMSI, wherein the second physical broadcast channel transmission indicates the quantity of radio frames included in the time window.

26. The network entity of claim 18, wherein the one or more processors are individually or collectively further operable to execute the code to cause the network entity to:
output the first RMSI message while the UE is in a first radio resource control state, and wherein outputting the physical broadcast channel transmission comprises outputting the physical broadcast channel transmission while the UE is in a second radio resource control state different than the first radio resource control state.

27. The network entity of claim 18, wherein the one or more processors are individually or collectively further operable to execute the code to cause the network entity to:
output, to the UE, a control message that indicates a list of neighbor cells and a respective identifier associated with RMSI for each neighbor cell.

28. The network entity of claim 18, wherein the one or more processors are individually or collectively further operable to execute the code to cause the network entity to:
output, to the UE, control signaling that indicates to delete the first RMSI.

29. A method for wireless communications at a user equipment (UE), comprising:
receiving first remaining minimum system information (RMSI) via a first RMSI message, wherein the first RMSI message indicates a first identifier associated with the first RMSI;
receiving, from a cell and after the first RMSI message, a physical broadcast channel transmission that indicates a second identifier associated with second RMSI associated with the cell during a time window; and
selecting to decode or refrain from decoding a second RMSI message associated with the cell during the time window based at least in part on whether the first identifier matches the second identifier.

30. A method for wireless communications at a network entity, comprising:
outputting, to a user equipment (UE), first remaining minimum system information (RMSI) via a first RMSI message associated with a cell, wherein the first RMSI message indicates a first identifier associated with the first RMSI, and wherein the cell is associated with the network entity; and
outputting, to the UE and after the first RMSI message, a physical broadcast channel transmission that indicates a second identifier associated with second RMSI associated with the cell during a time window.
